(19) United States
(12) Patent Application Publication
(10) Pub. No.: US 2016/0149263 A1
(43) Pub. Date: May 26, 2016

(54) LITHIUM ION ELECTROLYTES WITH LIFSI FOR IMPROVED WIDE OPERATING TEMPERATURE RANGE

(71) Applicants: Johnson Controls Technology Company, Holland, MI (US); California Institute of Technology, Pasadena, CA (US)

(72) Inventors: Boutros Hallac, Franklin, WI (US); Marshall C. Smart, Studio City, CA (US); Frederick C. Krause, Los Angeles, CA (US); Bernhard M. Metz, Milwaukee, WI (US); Ratnakumar V. Bugga, Arcadia, CA (US)

(21) Appl. No.: 14/952,493

(22) Filed: Nov. 25, 2015

Related U.S. Application Data
(60) Provisional application No. 62/084,711, filed on Nov. 26, 2014.

(51) Int. Cl. H01M 10/0568; H01M 2/02; H01M 4/485; H01M 10/0567; H01M 10/0525; H01M 10/0569

(52) U.S. Cl. CPC H01M 10/0568; H01M 10/0525; H01M 10/0569; H01M 4/485; H01M 10/0567; H01M 2/0237; H01M 2004/027

(57) ABSTRACT

A lithium ion battery cell includes a housing, a cathode disposed within the housing, wherein the cathode comprises a cathode active material, an anode disposed within the housing, wherein the anode comprises an anode active material, and an electrolyte disposed within the housing and in contact with the cathode and anode. The electrolyte includes a solvent mixture and a lithium salt serving as a primary lithium ion conductor in the electrolyte to allow for lithium ion intercalation and deintercalation processes at the cathode and the anode during charging and discharging of the lithium ion battery cell. The solvent mixture includes a cyclic carbonate and one or more non-cyclic carbonates. The lithium salt is lithium bis(fluorosulfonyl)imide (LiFSI). The solvent mixture and LiFSI are configured to enhance the low temperature performance of the lithium ion battery cell at operating temperatures below 0° C.

### CROSS REFERENCE TO RELATED APPLICATIONS

This application claims priority from and the benefit of U.S. Provisional Application Ser. No. 62/084,711, entitled “Ester-Containing Li-ion Electrolytes with LiFSI and Low Viscosity Co-Solvents for Improved Wide Operating Temperature Range,” filed Nov. 26, 2014, which is hereby incorporated by reference in its entirety for all purposes.

### STATEMENT REGARDING FEDERALLY SPONSORED RESEARCH & DEVELOPMENT

The invention described herein was made in the performance of work under a NASA contract, and is subject to the provisions of Public Law 96-517 (35 USC §202) in which the Contractor has elected to retain title.

### BACKGROUND

The present disclosure relates generally to the field of lithium-ion batteries and battery modules. More specifically, the present disclosure relates to battery cells that may be used in vehicular contexts, as well as other energy storage/expending applications.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A vehicle that uses one or more battery systems for providing all or a portion of the motive power for the vehicle can be referred to as an xEV, where the term “xEV” is defined herein to include all of the following vehicles, or any variations or combinations thereof, that use electric power for all or a portion of their vehicular motive force. For example, xEVs include electric vehicles (EVs) that utilize electric power for all motive force. As will be appreciated by those skilled in the art, hybrid electric vehicles (HEVs), also considered xEVs, combine an internal combustion engine propulsion system and a battery-powered electric propulsion system, such as 48 Volt (V) or 130V systems. The term HEV may include any variation of a hybrid electric vehicle. For example, full hybrid systems (FHEVs) may provide motive and other electrical power to the vehicle using one or more electric motors, using only an internal combustion engine, or using both. In contrast, mild hybrid systems (MHEVs) disable the internal combustion engine when the vehicle is idling and utilize a battery system to continue powering the air conditioning unit, radio, or other electronics, as well as to restart the engine when propulsion is desired. The mild hybrid system may also apply some level of power assist, during acceleration for example, to supplement the internal combustion engine. Mild hybrids are typically 96V to 130V and recover braking energy through a belt or crank integrated starter generator. Further, a micro-hybrid electric vehicle (mHEV) also uses a “Stop-Start” system similar to the mild hybrids, but the micro-hybrid systems of a mHEV may or may not supply power assist to the internal combustion engine and operates at a voltage below 60V. For the purposes of the present discussion, it should be noted that mHEVs typically do not technically use electric power provided directly to the crankshaft or transmission for any portion of the motive force of the vehicle, but an mHEV may still be considered as an xEV since it does use electric power to supplement a vehicle's power needs when the vehicle is idling with internal combustion engine disabled and recovers braking energy through an integrated starter generator. In addition, a plug-in electric vehicle (PEV) is any vehicle that can be charged from an external source of electricity, such as wall sockets, and the energy stored in the rechargeable battery packs drives or contributes to drive the wheels. PEVs are a subcategory of EVs that include all-electric or battery electric vehicles (BEVs), plug-in hybrid electric vehicles (PHEVs), and electric vehicle conversions of hybrid electric vehicles and conventional internal combustion engine vehicles.

xEVs as described above may provide a number of advantages as compared to more traditional gas-powered vehicles using only internal combustion engines and traditional electrical systems, which are typically 12V systems powered by a lead acid battery. For example, xEVs may produce fewer undesirable emission products and may exhibit greater fuel efficiency as compared to traditional internal combustion vehicles and, in some cases, such xEVs may eliminate the use of gasoline entirely, as is the case of certain types of EVs or PEVs.

As xEV technology continues to evolve, there is a need to provide improved power sources (e.g., battery systems or modules) for such vehicles. For example, it is desirable to increase the distance that such vehicles may travel without the need to recharge the batteries. Additionally, it may also be desirable to improve the performance of such batteries and to reduce the cost associated with the battery systems. In particular, it may be desirable for an xEV battery power source to enable operation of the xEV in a number of environments (e.g., high and low temperature environments, humid environments, arid environments).

### SUMMARY

The present disclosure relates generally to the field of lithium-ion batteries and battery modules. More specifically, the present disclosure relates to battery cells that may be used in vehicular contexts, as well as other energy storage/expending applications.

In one embodiment, a lithium ion battery cell includes a housing, a cathode disposed within the housing, wherein the cathode comprises a cathode active material, an anode disposed within the housing, wherein the anode comprises an anode active material, and an electrolyte disposed within the housing and in contact with the cathode and anode. The electrolyte includes a solvent mixture and a lithium salt serving as a primary lithium ion conductor in the electrolyte to allow for lithium ion intercalation and deintercalation processes at the cathode and the anode during charging and discharging of the lithium ion battery cell. The solvent mixture may include a cyclic carbonate, and one or more non-cyclic carbonates, and a non-cyclic ester. The lithium salt is lithium bis(fluorosulfonyl)imide (LiFSI). The solvent mixture and LiFSI are configured to enhance the low temperature performance of the lithium ion battery cell at operating temperatures below 0° C.

In another embodiment, a lithium ion battery cell includes a housing, a cathode disposed within the housing, wherein the cathode comprises a cathode active material, an anode disposed within the housing, wherein the anode comprises an anode active material, and an electrolyte disposed within the housing and in contact with the cathode and anode. The electrolyte includes a solvent mixture, a lithium salt serving as a primary lithium ion conductor in the electrolyte to allow for lithium ion intercalation and deintercalation processes at the cathode and the anode during charging and discharging of the lithium ion battery cell, and lithium bis(fluorosulfonyl)imide (LiFSI) serves as an additive. The solvent mixture may include a cyclic carbonate, first and second non-cyclic carbonates, and one or more non-cyclic esters. The solvent mixture and the LiFSI additive are configured to enhance the low temperature performance of the lithium ion battery cell at operating temperatures below 0° C.

In a further embodiment, a lithium ion battery cell includes a housing, a cathode disposed within the housing, wherein the cathode comprises a cathode active material; an anode disposed within the housing. The anode includes a titanate-based active material, and an electrolyte disposed within the housing and in contact with the cathode and anode. The electrolyte includes a solvent mixture, a lithium salt, and one or more additives. The one or more additives include a vinyl trialkoxysilane, or a partially fluorinated ester, or a combination thereof

### DRAWINGS

Various aspects of this disclosure may be better understood upon reading the following detailed description and upon reference to the drawings in which:

FIG. 1 is a perspective view of an xEV having a battery system configured in accordance with present embodiments to provide power for various components of the xEV, in accordance with an aspect of the present disclosure;

FIG. 2 is a cutaway schematic view of an embodiment of the xEV having a start-stop system that utilizes the battery system of FIG. 1, the battery system having a lithium ion battery module, in accordance with an aspect of the present disclosure;

FIG. 3 is a perspective view of an embodiment of a lithium ion battery cell having a prismatic configuration, in accordance with an aspect of the present disclosure;

FIG. 4 is a perspective view of an embodiment of a lithium ion battery cell having a pouch configuration, in accordance with an aspect of the present disclosure;

FIG. 5 is a plot of area specific impedance (ASI) as a function of percent state of charge (% SOC) obtained at −30° C. at a 5C discharge rate for battery cells having various fluorinated lithium salts, in accordance with an aspect of the present disclosure; and

FIGS. 6 and 7 are plots of ASI as a function of % SOC obtained at −25° C. and −30° C., respectively, at a 5C discharge rate for battery cells having vinyl trialkoxysilane and partially fluorinated ester additives, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The battery systems described herein may be used to provide power to a number of different types of xEVs as well as other energy storage applications (e.g., electrical grid power storage systems). Such battery systems may include one or more battery modules, each battery module having a number of battery cells (e.g., lithium ion cells) arranged to provide particular voltages and/or currents useful to power, for example, one or more components of an xEV. Accordingly, presently disclosed are a number of systems and methods for the manufacture of battery cells that enable good power capability at low temperatures (e.g., down to about −30° C.) and good life characteristics at relatively high temperatures of operation (e.g., 60° C.). For example, one important limitation associated with traditional automotive lithium ion batteries are the poor sub-ambient temperature performance due to relatively high impedance at low temperatures (e.g., 0 to −40° C.). Indeed, impedance is an important consideration at both the anode and cathode side of a lithium ion battery cell, since it can determine how fast the cell can be charged and discharged.

Charge and discharge rates are of particular concern in configurations where lithium ion batteries are intended to be used in parallel with or instead of lead acid batteries. In fact, it has proven very challenging to construct lithium ion battery cells having a combination of an appropriate size, an appropriate capacity, and appropriate cold cranking capabilities at low temperature (e.g., −30° C.) and high (e.g., 10C) charge/discharge rates, to match lead acid batteries. As one example, micro hybrid systems place high demands on power requirements, and batteries used in these applications should be capable of a pulse charge/discharge power of 12 kW, and an engine cranking power of 5 kW at −30° C. Indeed, it is now recognized that it may be desirable to produce a lithium ion battery module capable of, for example, meeting a 12C cranking performance target of 10 seconds of consecutive cranking, for 3 times, at a 12C rate at −18° C. and a 5C rate at −30° C., a high temperature cycling performance target at 60° C. using 4C discharge/1C charge cycles, for >1000 cycles and with 80% capacity retention, and a high temperature calendar life performance target at 60° C. for 6 months with a capacity retention >80% and cell impedance growth <50%.

Electrolytes used in lithium ion battery cells, which may in turn be incorporated into larger battery modules and battery systems may include a variety of components. The components of the electrolytes may all affect the performance and stability of the lithium ion battery cell under particular operating conditions. The different electrolyte components may be used, for example, to provide certain levels of ionic conductivity, electrode/electrolyte interfacial effects, electrolyte stability under certain operating conditions, and other properties.

As is generally understood in the art, an “electrolyte” as used herein is intended to denote a single composition having all solvents, co-solvents, additives, lithium salts, and so forth, used in a particular battery cell. Therefore, it should also be noted that the term “electrolyte” is understood in the art to denote a solution incorporating all such materials, and is not generally intended to be limited to only the lithium salt (or other ionic material) used to provide ionic conductivity to a solution. Rather, a “lithium salt” will generally denote the salt that is an ionic conductor that allows for intercalation/deintercalation processes to occur at the cathode and anode during charging and discharging of the electrochemical cell (battery cell). Lithium salts are generally expressed in terms of their molarity (M) in the solvents of the electrolyte. However, certain additives may also be denoted as being present in a certain molarity that is lower than the corresponding lithium salt molarity. The solvents of the electrolyte compositions, for lithium ion battery cells, are non-aqueous, and are generally expressed in terms of their relative volume percentages, based on the total volume of solvents in the electrolyte composition. In this way, the volume percentages of solvents in a particular electrolyte will total 100 volume percent (% v/v or vol %). Additives of the disclosed electrolytes are generally expressed in terms of weight percentage (wt %) of the total composition of the electrolyte. In this way, it may be possible to determine if a particular component of an electrolyte is a solvent, lithium salt, additive, or the like, with reference to the manner in which its amount is expressed as well as the amount of the component relative to other components. It should also be noted that an “electrolyte” may also be referred to as an “electrolyte composition” or a “lithium ion electrolyte” in some situations.

In accordance with certain embodiments of the present disclosure, the use of certain low viscosity ester-based solvents and/or carbonate-based solvent blends in an electrolyte may at least partially contribute to enhanced performance at wide operating temperature ranges for a lithium ion battery cell. Alkyl butyrates such as methyl butyrate (MB) and propyl butyrate (PB), and alkyl propionates such as methyl propionate (MP), are examples of such ester solvents. These example esters may have desirable physical properties (viscosity, melting points, and boiling points) and favorable compatibility for certain types of applications, such has micro-hybrid applications. Other ester co-solvents can be used in accordance with the present disclosure, including alkyl acetates and other alkyl propionates and alkyl butyrates. The presently disclosed electrolytes may also use fluorinated esters, which may contribute to enhanced lithium ion battery cell performance over a wide temperature range. The particular combinations and amounts of solvents used in a given electrolyte may vary, and example combinations are described in further detail below.

Certain lithium ion electrolytes disclosed herein may be limited, from the standpoint of the solvents in the electrolyte, to the use of only alkyl esters and carbonates in certain combinations. However, in its most general sense, the present disclosure encompasses the use of, in addition to or in lieu of carbonate and/or ester electrolyte solvents, other low viscosity electrolytes. These other low viscosity electrolytes may be used to improve the power capability of a lithium ion battery cell at low temperatures. In accordance with such embodiments and by way of example, certain of the presently disclosed electrolytes may include aggressive solvents such as acetonitrile (AN), 1,2-dimethoxy ethane (DME), and dimethyl sulfoxide (DMSO), either individually or in various combinations. Certain ester solvents, such as methyl acetate (MA), may be considered to represent a similarly aggressive solvent that maintains low viscosity at relatively low temperatures (e.g., −30° C.). Examples of electrolytes incorporating these solvents are also described in further detail below.

Additives used in the presently disclosed electrolytes may be used for a variety of reasons and may take a variety of forms. For example, additives used in the presently disclosed electrolytes may include certain lithium salts (e.g., certain lithium borates and/or lithium imides), certain cyclic carbonates, certain sultones, and fluorinated derivatives of these compounds. The additives may be used to, for example, enhance electrolyte/electrode interfacial characteristics, enhance electrode surface stability, and so forth. In one aspect of the present disclosure, additives used in certain lithium ion electrolytes may include vinyl trialkoxysilanes and/or partially fluorinated esters, which may reduce interfacial impedance at the anode and/or cathode of a lithium ion battery cell. Example silanes include vinyl trimethoxysilane (VTMS) and vinyl triethoxysilane (VTES), though other silanes are also within the scope of the present disclosure. Partially fluorinated esters may include, by way of example, 2,2,2-trifluoroethyl butyrate (TFEB) and ethyl trifluoroacetate (ETFA).

In accordance with one aspect of the present disclosure, it is also now recognized that, in addition to particular combinations of solvents and additives in a lithium ion electrolyte, certain lithium salts may provide enhanced stability and performance for micro-hybrid applications, among others. In certain presently disclosed electrolytes, lithium bis(fluorosulfonyl)imide (LiFSI) may be used as the primary lithium ion conductor of the electrolyte, i.e., as the lithium salt. LiFSI may be used in conjunction with other lithium salts, such as LiPF₆, or in lieu of other lithium ion conductors. As described in further detail below, the use of LiFSI, particularly as the exclusive lithium salt, may be used to enhance low temperature power capability compared to, for example, LiPF₆-based lithium ion electrolytes. It is also now recognized that in certain electrolytes, LiFSI results in a more stable electrolyte compared to other imide salts, such as lithium bis(trifluoromethanesulfonyl)imide (LiTFSI) or LiPF₆. In the present disclosure, it is believed that particular combinations of low-viscosity solvents, additives, and lithium salts as set forth above may unexpectedly improve the performance and stability of individual electrodes and overall battery cells, particularly at low temperature (e.g., −30° C.).

The presently disclosed electrolytes may be employed in a variety of applications, as set forth above. For example, the presently disclosed electrolytes may be particularly useful in situations where a lithium ion battery cell is desired to have a balance of stability and performance over a wide operating temperature range (e.g., from −30° C. to 60° C.). Indeed, it is believed that certain of the electrolytes described in further detail below may be particularly suited for micro-hybrid applications, a non-limiting example of which is described herein.

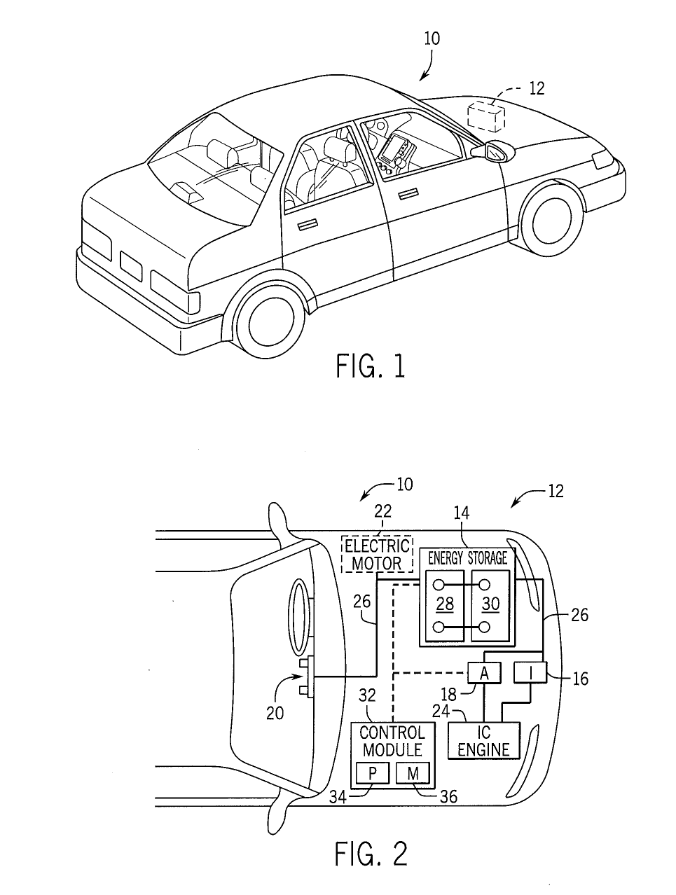

To help illustrate, FIG. 1 is a perspective view of an embodiment of a vehicle 10, which may utilize a regenerative braking system. Although the following discussion is presented in relation to vehicles with regenerative braking systems, the techniques described herein are adaptable to other vehicles that capture/store electrical energy with a battery, which may include electric-powered and gas-powered (or other fuel-powered) vehicles.

It is now recognized that it is desirable for a non-traditional battery system 12 (e.g., a lithium ion car battery) to be largely compatible with traditional vehicle designs. In this respect, present embodiments include various types of battery modules for xEVs and systems that include xEVs. Accordingly, the battery system 12 may be placed in a location in the vehicle 10 that would have housed a traditional battery system. For example, as illustrated, the vehicle 10 may include the battery system 12 positioned similarly to a lead-acid battery of a typical combustion-engine vehicle (e.g., under the hood of the vehicle 10). Furthermore, as will be described in more detail below, the battery system 12 may be positioned to facilitate managing temperature of the battery system 12. For example, in some embodiments, positioning a battery system 12 under the hood of the vehicle 10 may enable an air duct to channel airflow over the battery system 12 and cool the battery system 12.

A more detailed view of the battery system 12 is described in FIG. 2. As depicted, the battery system 12 includes an energy storage component 14 coupled to an ignition system 16, an alternator 18, a vehicle console 20, and optionally to an electric motor 22. Generally, the energy storage component 14 may capture/store electrical energy generated in the vehicle 10 and output electrical energy to power electrical devices in the vehicle 10.

In other words, the battery system 12 may supply power to components of the vehicle's electrical system, which may include radiator cooling fans, climate control systems, electric power steering systems, active suspension systems, auto park systems, electric oil pumps, electric super/turbochargers, electric water pumps, heated windscreen/defrosters, window lift motors, vanity lights, tire pressure monitoring systems, sunroof motor controls, power seats, alarm systems, infotainment systems, navigation features, lane departure warning systems, electric parking brakes, external lights, or any combination thereof. Illustratively, in the depicted embodiment, the energy storage component 14 supplies power to the vehicle console 20 and the ignition system 16, which may be used to start (e.g., crank) the internal combustion engine 24.

Additionally, the energy storage component 14 may capture electrical energy generated by the alternator 18 and/or the electric motor 22. In some embodiments, the alternator 18 may generate electrical energy while the internal combustion engine 24 is running. More specifically, the alternator 18 may convert the mechanical energy produced by the rotation of the internal combustion engine 24 into electrical energy. Additionally or alternatively, when the vehicle 10 includes an electric motor 22, the electric motor 22 may generate electrical energy by converting mechanical energy produced by the movement of the vehicle 10 (e.g., rotation of the wheels) into electrical energy. Thus, in some embodiments, the energy storage component 14 may capture electrical energy generated by the alternator 18 and/or the electric motor 22 during regenerative braking. As such, the alternator and/or the electric motor 22 are generally referred to herein as a regenerative braking system.

To facilitate capturing and supplying electric energy, the energy storage component 14 may be electrically coupled to the vehicle's electric system via a bus 26. For example, the bus 26 may enable the energy storage component 14 to receive electrical energy generated by the alternator 18 and/or the electric motor 22. Additionally, the bus 26 may enable the energy storage component 14 to output electrical energy to the ignition system 16 and/or the vehicle console 20. Accordingly, when a 12 volt battery system 12 is used, the bus 26 may carry electrical power typically between 8-18 volts.

Additionally, as depicted, the energy storage component 14 may include multiple battery modules. For example, in the depicted embodiment, the energy storage component 14 includes a lithium ion (e.g., a first) battery module 28 and a lead-acid (e.g., a second) battery module 30, which each includes one or more battery cells. In other embodiments, the energy storage component 14 may include any number of battery modules. Additionally, although the lithium ion battery module 28 and lead-acid battery module 30 are depicted adjacent to one another, they may be positioned in different areas around the vehicle. For example, the lead-acid battery module may be positioned in or about the interior of the vehicle 10 while the lithium ion battery module 28 may be positioned under the hood of the vehicle 10.

In some embodiments, the energy storage component 14 may include multiple battery modules to utilize multiple different battery chemistries. For example, when the lithium ion battery module 28 is used, performance of the battery system 12 may be improved since the lithium ion battery chemistry generally has a higher coulombic efficiency and/or a higher power charge acceptance rate (e.g., higher maximum charge current or charge voltage) than the lead-acid battery chemistry. As such, the capture, storage, and/or distribution efficiency of the battery system 12 may be improved.

To facilitate controlling the capturing and storing of electrical energy, the battery system 12 may additionally include a control module 32. More specifically, the control module 32 may control operations of components in the battery system 12, such as relays (e.g., switches) within energy storage component 14, the alternator 18, and/or the electric motor 22. For example, the control module 32 may regulate amount of electrical energy captured/supplied by each battery module 28 or 30 (e.g., to de-rate and re-rate the battery system 12), perform load balancing between the battery modules 28 and 30, determine a state of charge of each battery module 28 or 30, determine temperature of each battery module 28 or 30, control voltage output by the alternator 18 and/or the electric motor 22, and the like.

Accordingly, the control unit 32 may include one or processor 34 and one or more memory 36. More specifically, the one or more processor 34 may include one or more application specific integrated circuits (ASICs), one or more field programmable gate arrays (FPGAs), one or more general purpose processors, or any combination thereof. Additionally, the one or more memory 36 may include volatile memory, such as random access memory (RAM), and/or non-volatile memory, such as read-only memory (ROM), optical drives, hard disc drives, or solid-state drives. In some embodiments, the control unit 32 may include portions of a vehicle control unit (VCU) and/or a separate battery control module. Furthermore, as depicted, the lithium ion battery module 28 and the lead-acid battery module 30 are connected in parallel across their terminals. In other words, the lithium ion battery module 28 and the lead-acid module 30 may be coupled in parallel to the vehicle's electrical system via the bus 26.

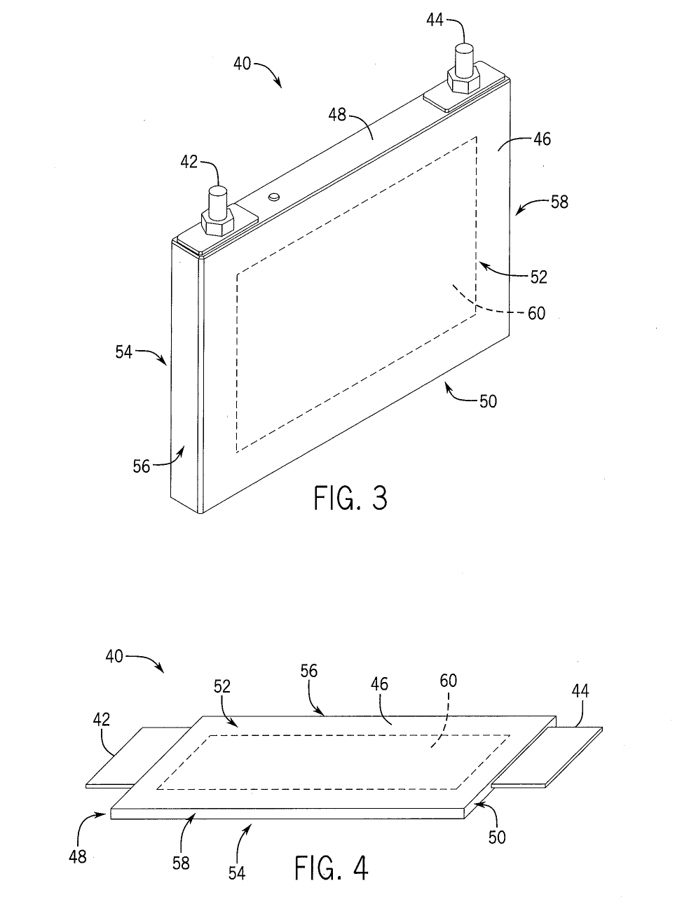

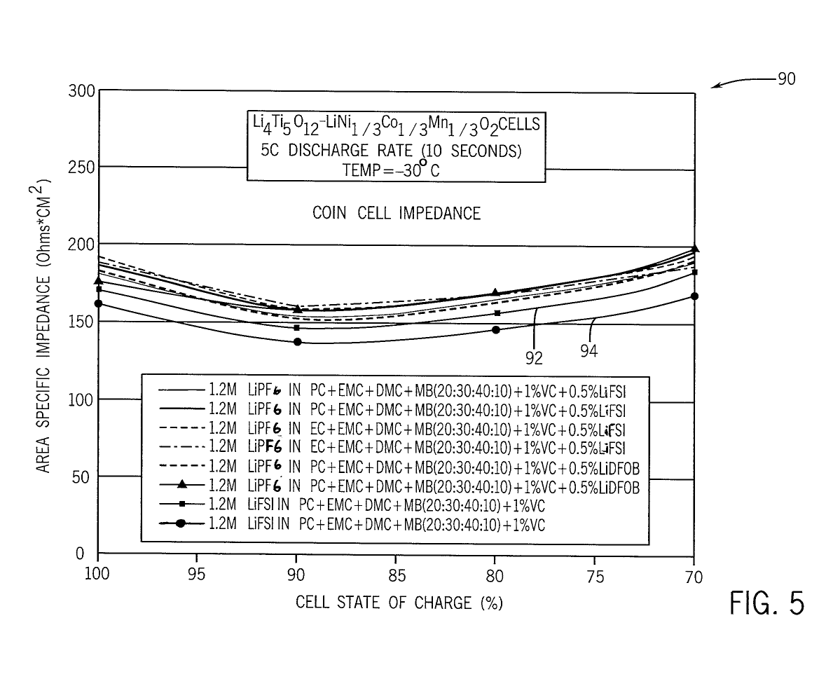

As set forth above, in accordance with the present disclosure, embodiments of the lithium ion battery module 28 may utilize specific chemistries to enable wide temperature operation, including operation at low temperatures (e.g., −20° C. and below). Embodiments of the lithium ion battery module 28 may include one or more battery cells connected so as to provide features for the acceptance, storage, and release of energy in the form of an electrical charge, electrical potential, and so forth. Illustratively, FIGS. 3 and 4 depict embodiments of a battery cell 40 used in the lithium ion battery module 28, and which may incorporate electrolytes of the present disclosure. Generally, and as discussed in further detail below, the battery cells 40 include a positive cell terminal 42, a negative cell terminal 44, and a housing 46 (also referred to as a casing) that contains the electrochemically active elements. However, the embodiments of the battery cell 40 illustrated in FIGS. 3 and 4 are merely provided as examples. In other embodiments, other shapes (e.g., oval, cylindrical, polygonal), sizes, terminal configuration and positions, and other features may be used in accordance with the present approach.

Specifically, FIG. 3 illustrates an embodiment of the lithium ion battery cell 40 having a prismatic configuration (i.e., is a prismatic battery cell), while FIG. 4 illustrates an embodiment of the lithium ion battery cell 40 having a pouch configuration (i.e., is a pouch battery cell). As may be appreciated with reference to FIGS. 3 and 4, the prismatic and pouch configurations are similar from the standpoint of the cross-sectional geometries of their respective housings 40, illustrated as generally rectangular. From the standpoint of producing battery modules having multiple battery cells, this rectangular shape generally affords higher energy densities and arrangement flexibility for the prismatic and pouch lithium ion battery cells 40 compared to other shapes, such as cylindrical configurations. However, this higher energy density and flexibility is usually balanced against possible losses in operating efficiencies due to non-symmetrical swelling and heating, among others.

Regarding the external features of the embodiments of the lithium ion battery cell 40, the illustrated prismatic configuration of FIG. 3 includes both terminals 42, 44 on the same region of the lithium ion battery cell 40. This region is generally considered to correspond to a top or terminal portion 48 of the lithium ion battery cell 40. The prismatic configuration illustrated in FIG. 3 includes a bottom or base portion 50 opposite the terminal portion 48, two faces (including first and second faces 52, 54) corresponding to the broad portion of the lithium ion battery cell 40, and first and second sides 56, 58 interconnecting the terminal portion 48 with the base portion 50 and the first face 52 with the second face 54. While illustrated as being substantially flat, the first and second sides 56, 58 may have other geometries, such as curved geometries. Further, while illustrated as including posts as the positive and negative terminals 42, 44, the prismatic configuration may instead use the terminal portion 48, the base portion 50, or any other portion of the casing 46, as one of the terminals, or may include pads for electrical connections.

Also illustrated in FIG. 3 is a dashed rectangle corresponding to an active area 60 of the lithium ion battery cell 40. The active area 60 generally denotes the region in the lithium ion battery cell 40 where a cathode and an anode of the lithium ion battery cell 40 are located. However, the illustrated size of the active area 60 is not intended to denote any particular dimensions of the cathode and anode, only the general positioning of the electrodes within the casing 48. The active area 60 may be considered to include a cell element including the anode, cathode, and other electrically active components.

The pouch configuration of the lithium ion battery cell 40 depicted in FIG. 4 includes tabs as the negative and positive terminals 42, 44. For the illustrated lithium ion battery cells 40 of FIGS. 3 and 4, the anode and cathode may be in the form of an oblong coil. As with the prismatic version of the battery cell 40 discussed above, the pouch battery cell 40 includes electrolytes having combinations of solvents and additives that together unexpectedly reduce impedance, even at low temperatures (e.g., below 0° C.). Further, the use of LiFSI, in combination with certain of the solvents set forth herein, may be more thermally stable compared to other lithium salts.

The lithium ion battery cell 40 of FIG. 4 also includes respective first and second faces 52, 54 corresponding to a portion of the cell 40 having the largest surface area relative to other sides or portions of the cell 40. While illustrated as also including respective terminal and bottom portions 48, 50, and first and second sides 56, 58, in other embodiments, the first and second faces 52, 54 may simply be coupled together via a seal (e.g., a laser or heat weld) extending around a periphery of the cell 40. The illustrated pouch version of the lithium ion battery cell 40 also includes a demarcation of the active area 60, which, as noted above, generally corresponds to a location of the anode and cathode of the lithium ion battery cell 40.

Regarding the construction of the anode and cathode, any suitable configuration may be used in combination with the presently disclosed electrolytes. As non-limiting examples, the anode and cathode may be in the form of an oblong coil or a series of stacked plates. For example, the anode may include a first active material coated onto a first conductive element (e.g., foil), and the cathode may include a second active material coated onto a second conductive element (e.g., foil). The anode active material and the cathode active material generally determine the operating voltage (or voltage range) of the lithium ion battery cell 40, with the electrolyte affecting the voltage as well.

In accordance with certain embodiments of the present disclosure, the anode active material may generally include any one or a combination of materials, such as carbon (e.g., graphite), natural graphite, artificial graphite, mesocarbon microbeads (MCMB), and coke based carbon, or lithium-titanium compounds such as lithium titanium oxide (lithium titanate, LTO, Li₄Ti₅O₁₂). For example, in one embodiment, the anode active material may be graphite, which has an average voltage of less than 200 milliVolts (mV) versus Li/Li⁺. However, in order to achieve enhanced stability against lithium plating, the anode active material may include a higher voltage material, such as one or more titanate-based materials. The use of LTO may be desirable compared to graphite, as it has a voltage of 1.55 V versus Li/Li⁺, and operates well outside of the voltage range at which lithium plating generally occurs, even at lower temperatures (e.g., down to −30° C.). Furthermore, the LTO may not undergo any major exothermic reactions with the electrolyte of the lithium ion battery cells 40, even at higher temperatures (e.g., up to 170° C.). While certain anode active materials may be more suitable for certain applications than others and, indeed, may contribute to certain of the results disclosed herein, the present disclosure is not particularly limited to any one anode active material unless otherwise noted with respect to particular embodiments. That is, the anode active material may include any one or a combination of appropriate active materials.

The cathode active material may, in its most general sense, include any active material capable of undergoing lithium intercalation and deintercalation at appropriate voltages. By way of non-limiting example, the cathode active material (the one or more materials used to produce the cathode) may have a voltage versus Li/Li⁺ of at least 2.5 V, such as between 3 V and 5 V, such as between 3.0 V and 4.9 V, between 3.0 V and 4.8 V, between 3.0 V and 4.7 V, between 3.0 V and 4.6 V, between 3.1 V and 4.5 V, between 3.1 V and 4.4 V, between 3.2 V and 4.3 V, between 3.2 V and 4.2 V, between 3.2 V and 4.1 V, or between 3.2 V and 4.0 V.

By way of example, the cathode active material may be a lithium metal oxide component. As used herein, lithium metal oxides may refer to any class of materials whose formula includes lithium and oxygen as well as one or more additional metal species (e.g., nickel, cobalt, manganese, aluminum, iron, or another suitable metal). A non-limiting list of example lithium metal oxides may include: mixed metal compositions including lithium, nickel, manganese, and cobalt ions such as lithium nickel cobalt manganese oxide NMC (e.g., LiₓNiₐMn_{b}Co_{c}O₂, x+a+b+c=2), lithium nickel cobalt aluminum oxide (NCA) (e.g., LiNiₓCo_{y}Al_{z}O₂, x+y+z=1), lithium cobalt oxide (LCO) (e.g., LiCoO₂), and lithium metal oxide spinel (e.g., LiMn₂O₄, such as high voltage spinel (HVS)). The cathode may include only a single active material (e.g., NMC), or may include a mixture of materials such as any one or a combination of: NMC, NCA, LCO, LMO-spinel, and the like.

Other cathode active materials may be utilized in addition to or in lieu of these materials, such as lithium metal phosphates. Examples of such active materials are generally defined by the formula LiMPO₄, wherein M is Fe, Ni, Mn, or Mg. Any one or a combination of these phosphates may be used as the cathode active material, in addition to or in lieu of any one or a combination of the lithium metal oxide materials encompassed by the description above. Thus, by way of example, the cathode active material may include any one or a combination of: NMC, LiMn₂O₄ (LMO) spinel, NCA, LiMn_{1.5}Ni_{0.5}O₂, LCO, or LiMPO₄, wherein M is Fe, Ni, Mn, or Mg. It should be noted, however, that a variety of cathode active materials may, in combination, be used at the cathode to achieve an appropriate voltage for the lithium ion battery cell 40.

Returning now to the architecture of the cells 40, the anode and cathode may be separated by a separator to prevent shorting, and may be wound around a mandrel to form an oblong coil. This forms a layered roll that, when combined with the electrolyte compositions of the present disclosure, may be referred to as a “jelly roll.” Stacked plate configurations may generally have a similar arrangement, but are discontinuous, not wound around a mandrel and are, instead, crimpled at either end so that the cathode plates connect to the cathode tab and the anode plates connect to the anode tab. Generally, the presently disclosed electrolytes may be placed into intimate contact with the anode and cathode via a filling procedure in which the electrolytes are introduced into the casing 46 containing the anode and cathode.

### Electrolyte

Present embodiments of the electrolytes, as noted above, may include specific combinations of lithium salts, carbonate and/or ester solvents, and certain additives. Specific combinations of these components may enable reduced impedance at relatively low temperatures and good capacity retention when used at elevated temperatures. In this way, the lithium ion battery cells 40 disclosed herein may be incorporated into battery modules (e.g., the lithium ion battery module 28) that may be subject to charge and discharge cycles at low temperatures and high temperatures, and the electrolytes disclosed herein may enable such charging and discharging at rates and lifetimes that may not otherwise be appropriate. Presented below are certain example materials that may be used to produce electrolytes for use in the battery cells 40 disclosed above. It should be noted that an electrolyte may generally include a lithium salt present in a certain concentration, in a solvent mixture of solvents having respective volume percentages, based on the total volume of the solvent mixture. Certain electrolytes may also include an additive present within a certain concentration, denoted as a concentration (e.g., 0.1 M) or as a certain weight percentage, based on the total weight of the electrolyte (wt %).

### Lithium Salt

The electrolytes disclosed herein generally include a lithium salt, which serves as a lithium ion conductor to allow for the lithium ion intercalation and deintercalation processes at the cathode and anode during charging and discharging. That is, the key function of the lithium salt is to provide ionic conduction in the cell and the transport of lithium ion between the cathode and anode during charging and discharging. The lithium salt may include any suitable conductor of lithium ions, with non-limiting, specific examples including lithium hexafluorophosphate (LiPF₆), lithium tetrafluoroborate (LiBF₄), lithium bis(oxalato)borate (LiBOB, LiB(C₂O₄)₂), lithium difluoro(oxalato)borate (LiDFOB), and lithium trifluoromethanesulfonate (lithium triflate, LiCF₃SO₃).

In accordance with one aspect of the present disclosure, the lithium salt may include lithium bis(fluorosulfonyl)imide (LiFSI), either alone or in combination with other lithium salts. As an example, an electrolyte produced in accordance with certain aspects of the present disclosure may use LiFSI as the only lithium salt. As another example, an electrolyte produced in accordance with certain aspects of the present disclosure may use LiFSI as the main or primary lithium salt (i.e., the lithium salt that has the highest relative weight percentage compared to other lithium salts). That is, LiFSI may be the primary lithium ion conductor that allows for intercalation and deintercalation processes at the cathode and anode during charging and discharging of the cell, as noted above. For instance, an electrolyte produced in accordance with certain aspect of the present disclosure may use LiFSI as a lithium salt representing greater than 50% by weight of the total lithium salts. As non-limiting examples, LiFSI may represent between 20% and 100% by weight of the lithium salts present in the electrolyte, such as between 40% and 99%, between 50% and 99%, between 60% and 99%, between 70% and 99%, between 80% and 99%, or between 90% and 99% by weight of the lithium salts present in the electrolyte. As described in further detail below, in certain particular embodiments, LiFSI may be used as the primary lithium salt in an electrolyte having multiple non-aqueous solvents including one or more non-cyclic (e.g., linear) esters, the battery cell being designed for operation at low temperature (e.g., below 0° C., such as down to about −30° C. or lower). That is, the LiFSI and the solvent mixture may be configured to enhance the performance of the battery cell at low temperatures (e.g., operating temperatures below 0° C.).

From a concentration standpoint, the amount of each lithium salt incorporated into the electrolyte may vary based on the number of lithium salts employed, and the chemical nature of the lithium salt. By way of non-limiting example, the total amount of lithium salts within the electrolyte may vary between 0.5 molar (M) and 2.0 M. As one specific example, a combination of lithium salts may include LiFSI and LiPF₆, where the LiFSI and the LiPF₆ are the only lithium salts present in the electrolyte (allowing for impurities).

In certain embodiments of the present disclosure, LiFSI is present in the electrolyte in a concentration ranging between 1.0 M and 2.0 M. By way of non-limiting example, LFSI may be present in the electrolyte in a concentration of between 1.0 M, and 1.6 M, such as 1.0 M, 1.2 M, or 1.6 M. Again, LiFSI may be the only lithium salt, or may be one of two or more lithium salts in the electrolyte.

In certain embodiments where LiFSI is the main or primary lithium salt in the electrolyte (i.e., the lithium salt present in the largest amount relative to other lithium salts), LiFSI may be present in a concentration between 1.0 M and 1.6 M, and the remaining lithium salts may be present in an amount of 0.2 M or less (e.g., between 0.05 M and 0.2 M, such as 0.1 M). The remaining lithium salts may include, for example, LiPF₆, LiBOB, LiDFOB, LiTFSI, or any other suitable lithium salt. In such embodiments, the other lithium salts may be considered to be additives, as opposed to one of the primary lithium salts that provide ionic conduction in the cell and the transport of lithium ions between the cathode and anode during charging and discharging.

As set forth above, the use of LiFSI as the main conductor of lithium ions as opposed to other lithium salts such as LiPF₆ or LiTFSI may result in enhanced conductivity at relatively low temperatures. Indeed, it has been found, as described with respect to certain examples below, that LiFSI may contribute to higher coulombic efficiencies relative to other lithium salts that are the main conductor of lithium ions (e.g., LiPF₆). Further, it is believed that LiFSI, in certain of the electrolytes described below, may have improved temperature stability relative to other lithium salts as it is less susceptible to forming side products that can have deleterious effects on the battery cell. For instance, LiFSI may be less susceptible to forming hydrofluoric acid (HF) relative to other lithium salts such as LiPF₆ or LiTFSI. A reduction in the formation of HF may be desirable as HF may, within the conditions of the battery cell 40, in turn form lithium fluoride (LiF), which is highly electrically insulative and can coat the anode of the battery cell 40. Thus, LiFSI may beneficially maintain the conductivity of the battery cell 40 (e.g., may produce an electrolyte having a lower resistance compared to other lithium salts). In one embodiment, LiFSI is the only lithium salt used to produce the electrolyte, which may decrease the likelihood of LiF formation.

### Electrolyte Solvents

In accordance with certain embodiments of the present disclosure, the use of certain low viscosity ester-based solvents and/or carbonate-based solvent blends in an electrolyte may at least partially contribute to enhanced performance at wide operating temperature ranges for a lithium ion battery cell, including low temperature operation (e.g., below 0° C.). This may be particularly true when such solvents or solvent mixtures are used in combination with certain of the primary lithium salts (e.g., LiFSI) and/or other additives described herein. The solvents of the electrolytes may include one or more ester solvents, one or more carbonate solvents, or a combination thereof. Generally, the ester solvents may be linear esters, branched esters, or the electrolyte solvent mixture may include both linear and branched esters (i.e., non-cyclic carbonates). A non-limiting list of example non-cyclic (e.g., linear) ester solvents includes alkyl acetates, alkyl propionates, and alkyl butyrates. A non-limiting list of such esters may include: methyl butyrate (MB), methyl propionate (MP), propyl butyrate (PB), ethyl propionate (EP), ethyl butyrate (EB), butyl butyrate (BB), methyl acetate (MA), ethyl acetate (EA), propyl propionate (PP), butyl propionate (BP), propyl acetate (PA), and butyl acetate (BA). The non-cyclic ester solvents may be selected based upon their viscosity, boiling point, melting point, dielectric constant, and so forth. As one example, a single non-cyclic ester may be used in an electrolyte solvent mixture, the non-cyclic ester having a relatively low viscosity at temperatures lower than −10° C., such as MB, MP, or EP. These example esters may have desirable physical properties (viscosity, melting points, and boiling points) and favorable compatibility for certain types of applications, such has micro-hybrid applications. The presently disclosed electrolytes may also use fluorinated esters, which may contribute to enhanced lithium ion battery cell performance over a wide temperature range.

The carbonate solvents may be cyclic carbonates, acyclic (non-cyclic) carbonates, or the electrolyte solvent mixture may include both cyclic and non-cyclic carbonates alone or, in certain embodiments where low temperature performance is desired, in combination with one or more non-cyclic esters. A non-limiting list of example carbonate solvents include cyclic carbonates such as ethylene carbonate (EC), fluoroethylene carbonate (FEC), and propylene carbonate (PC), and non-cyclic (e.g., straight-chain) carbonates such as ethyl methyl carbonate (EMC), dimethyl carbonate (DMC), and diethyl carbonate (DEC). Any combination of ester and carbonate solvents is encompassed by the present disclosure, but certain solvent mixtures have been found to result in better battery cell performance than others for certain electrolyte compositions, as described in further detail below. By way of non-limiting example, an electrolyte solvent mixture may include a combination of one or two cyclic carbonate solvents, one or two non-cyclic carbonate solvents, and one or two ester solvents. By way of more specific example, an electrolyte solvent mixture may include a combination of one cyclic carbonate solvent, two non-cyclic carbonate solvents, and one non-cyclic ester solvent.

Further, the use of only carbonate solvents is also encompassed by the present disclosure. For example, certain of the disclosed electrolytes may have a solvent mixture that includes only one or more carbonate solvents, such as one or more linear carbonates and one or more cyclic carbonates, such as only one linear carbonate or only one cyclic carbonate, or only one linear carbonate and one cyclic carbonate.

Other solvents, such as acetonitrile (AN or ACN), 1,2-dimethoxy ethane (DME), and dimethyl sulfoxide (DMSO), or in some embodiments methyl acetate (MA), may be used with a carbonate-only solvent mixture, or a carbonate and ester solvent mixture. These solvents may be considered to constitute low viscosity solvents and/or aggressive solvents. For example, AN and/or DME may be used in combination with or in lieu of certain low viscosity esters, including but not limited to MB. MA may also be used in place of or in addition to other ester solvents. Indeed, while these solvents may be considered to be too aggressive for certain battery cell constructions (e.g., having certain active materials), embodiments of the battery cell 40 having NMC/LTO active material chemistry may tolerate such solvents, which may improve low temperature performance (e.g., improve conductivity at low temperatures).

In certain embodiments, the one or more non-cyclic ester solvents may account for greater than 40 vol %, 50 vol %, or 60 vol % of the electrolyte. In embodiments where the non-cyclic ester solvent is considered to be the major solvent of the solvent mixture (i.e., the solvent representing the largest volume relative to the other solvents), the ester solvent (e.g., MB) may be present in the electrolyte solvent mixture in an amount ranging from 40 vol % to 70 vol %. For example, the non-cyclic ester may be present in an amount between 50 vol % and 70 vol %, or 60 vol %, and the cyclic and non-cyclic carbonates may represent the remaining volume of solvent in the electrolyte. However, any amount of the non-cyclic ester solvent may be utilized. Indeed, in certain other embodiments, the non-cyclic ester may represent a volume percentage that is less than any one of the remaining solvents. For example, in embodiments where the non-cyclic ester is a minor solvent (has a volume percentage that is less than any one other solvent), the non-cyclic ester may be present in an amount ranging from 5 vol % to 30 vol %, such as between 5 vol % and 25 vol %, 5 vol % and 20 vol %, or 10 vol %.

The carbonates may be present in equal volume percentages, or different volume percentages. As a further example, in embodiments where the non-cyclic ester represents the majority of the solvents in the electrolyte, the cyclic carbonate may be present in an amount ranging from 5 vol % to 40 vol %, such as 10 vol %, 15 vol %, 20 vol %, 25 vol %, or 30 vol %. The non-cyclic carbonates may each be present in an amount ranging from 5 vol % to 40 vol %, such as 10 vol %, 15 vol %, 20 vol %, 25 vol %, or 30 vol %. As yet another example, in embodiments where the non-cyclic ester does not represent the majority of the solvents in the electrolyte, the cyclic carbonate may be present in an amount ranging from 5 vol % to 80 vol %, such as between 10 vol % and 70 vol %, or between 20 vol % and 60 vol %. Correspondingly, the non-cyclic carbonates may each be present in an amount ranging from 5 vol % to 80 vol %, such as between 10 vol %, and 70 vol %, or between 20 vol % and 60 vol %. Example volume percentages for the cyclic carbonates and/or non-cyclic carbonates include 5 vol %, 10 vol %, 20 vol %, 25 vol %, 30 vol %, 40 vol %, 50 vol %, or 60 vol %.

In certain embodiments where multiple non-cyclic carbonates are utilized (e.g., a first non-cyclic carbonate and a second non-cyclic carbonate), the non-cyclic carbonates may, together, represent between 40 vol % and 80 vol % of the total volume of the solvent mixture. As another example, the first and second cyclic carbonates may together represent between 10 vol % and 30 vol % of the total volume of the solvent mixture.

The particular chemistry of the electrolyte solvents used in the electrolyte compositions of the present disclosure may depend on a number of factors, including the identity of the lithium salt serving as the primary lithium ion conductor, the active materials used for the cathode and anode, the chemistry of the additives used in the electrolyte, and so forth. As one example, it is commonly recognized that EC is used as a cyclic carbonate for battery cells that utilize graphite as an anode active material, since certain electrolytes, such as PC, exfoliate and degrade anodes that utilize graphite as an active material (e.g., via co-intercalation with Li⁺). Indeed, if EC is not utilized, it has been found that the graphite active material at the anode can quickly degrade. In accordance with one aspect of the present disclosure, such as when the graphite is replaced with a titanate-based anode, EC can be replaced, partially or entirely, by other carbonate solvents. Examples include PC or a fully or partially fluorinated carbonate such as fluoroethylene carbonate (FEC). Such substitution may improve the performance of the battery cell 40 when used in combination with certain other electrolyte materials.

As one example of the solvents used in an electrolyte of the present disclosure, the solvent mixture may consist essentially of a cyclic carbonate (e.g., FEC, EC, PC), a first non-cyclic carbonate (e.g., EMC), a second non-cyclic carbonate (e.g., DMC), and a non-cyclic (e.g., linear) ester (e.g., MB, MP, PB, EP). The cyclic carbonate may be present in an amount between 5 vol % and 30 vol % based on the total volume of the solvent mixture, the first and second non-cyclic carbonates together may represent between 40 vol % and 80 vol % of the total volume of the solvent mixture, and the linear ester may be present in an amount between 5 vol % and 20 vol %, based on the total volume of the solvent mixture. In certain embodiments, the volume percentage of the cyclic carbonate is greater than or equal to the volume percentage of the linear ester.

As set forth above, certain other solvents, such as AN, DME, MA, or DMSO may be used in lieu of the linear ester described above. These solvents may be desirable for their conductivity, but are typically considered to be aggressive co-solvents that can potentially degrade the electrode active materials (e.g., through exfoliation of the active material away from the anode or cathode). Surprisingly, it has been found that AN and MA can be used in appreciable amounts (e.g., as the main solvent mixture component) in combination with certain additives with acceptable levels of capacity loss. As set forth in the examples below, AN and MA, when incorporated into a solvent mixture, may provide enhanced rate capabilities at low temperature (e.g., −30° C.) compared to other solvent mixtures.

As one example of the solvent mixture used in accordance with such embodiments, the solvent mixture may consist essentially of a cyclic carbonate (e.g., FEC, EC, PC), a first non-cyclic carbonate (e.g., EMC), a second non-cyclic carbonate (e.g., DMC), and one or more of AN, MA, DME, or DMSO. Any relative amounts of these solvents may be used. In accordance with certain embodiments, the cyclic carbonate may be present in an amount between 5 vol % and 30 vol % based on the total volume of the solvent mixture. The first and second non-cyclic carbonates together may represent between 10 vol % and 80 vol % of the total volume of the solvent mixture, and AN, MA, DME, or DMSO may be present in an amount between 5 vol % and 50 vol %, based on the total volume of the solvent mixture. In certain embodiments, AN, MA, DME, or DMSO is the major solvent while in other embodiments, AN, MA, DME, or DMSO is a minor solvent. In other embodiments, the solvent mixture may include but not be limited to the linear and cyclic carbonates, and AN, MA, DME, or DMSO. For example, in certain embodiments, the solvent mixture may include a linear ester (other than MA) in addition to such solvents, in any amount (such as the amounts set forth above). However, in other embodiments, the solvent mixture may include but not be limited to the carbonate solvents and AN, MA, DME, or DMSO, but may exclude linear esters (other than MA, when used).

By way of specific, but non-limiting example, in embodiments where the battery cell 40 includes graphite or LTO as an anode active material, one electrolyte solvent mixture may be EC/EMC (30:70 vol %), EC/EMC/MB (20:20:60 vol %), FEC/EMC/MB (20:20:60 vol %), FEC/EMC/PB (20:20:60 vol %), EC/EMC/DMC/MB (20:30:40:10 vol %), EC/EMC/DMC/MB (30:20:20:30 vol %), or FEC/EC/EMC/MB (10:10:20:60 vol %). By way of another specific, but non-limiting example, in embodiments where the battery cell 40 includes LTO or graphite as an anode active material, another electrolyte solvent mixture may be EC/EMC/MB (20:60:20 vol %), EC/EMC/MP (20:60:20 vol %), FEC/EMC/MB (20:20:60 vol %), EC/EMC/DMC/MB (20:30:40:10 vol %), EC/EMC/DMC (20:40:40 vol %), or EC/EMC/DMC/MP (20:30:40:10 vol %). In embodiments where the battery cell 40 includes LTO as an anode active material, another electrolyte solvent mixture may be PC/EMC/DMC/MB (20:30:40:10 vol %) or PC/EMC/DMC/MB (30:30:30:10 vol %). As yet a further example, when the anode active material includes LTO, another electrolyte solvent mixture may be EC/EMC/DMC/AN (20:20:20:40 vol %), EC/EMC/DMC/MA (20:20:20:40 vol %), EC/EMC/DMC/DME (20:20:20:40 vol %), or EC/EMC/DMC/DMSO (20:20:20:40 vol %). It is presently recognized, as set forth below, that certain of these solvent combinations and relative amounts, used in conjunction with, for example, LiFSI as the primary lithium salt, may result in enhanced low temperature performance. Particularly, in certain embodiments, a solvent mixture of a cyclic carbonate, one or more non-cyclic carbonates, and one or more non-cyclic esters used in combination with LiFSI as the primary lithium salt may result in enhanced low temperature battery cell performance (e.g., below 0° C.).

Again, it should be noted that these solvent mixtures are provided as examples, and while certain mixtures may provide better properties than others, are not intended to limit the scope of the present disclosure to these specific combinations. Indeed, any and all combinations of any and all of the solvents disclosed above are considered to be within the scope of this disclosure.

### Electrolyte Additives

Embodiments of the electrolytes disclosed herein also include one or more additives that enable improved cycle and calendar life throughout higher temperature operation (e.g., at temperatures of 45° C. or more), as well as lower temperature operation (e.g., at temperatures of 10° C. or less). In their most general sense, electrolyte additives used in accordance with the present disclosure may serve to stabilize the anode, cathode, or both, when the battery cell 40 undergoes formation and during operation. Indeed, in certain embodiments, one or more additives may be utilized within the electrolytes of the present disclosure to form protective films over the anode and cathode, which may otherwise be susceptible to degradation during charging and/or discharging, at high temperatures, and so forth. Further still, it is believed that certain of the additives disclosed herein may produce a solid electrolyte interface (SEI) layer at the cathode and/or anode, which can prolong the life of the electrodes. Further, it should also be noted that certain of the solvents disclosed above may form beneficial SEI layers for electrodes, and may be used in proportion to the other components of the electrolyte so as to be considered an additive.

In addition, certain of the additives may enhance the lithium kinetics at the anode or cathode (intercalation/deintercalation at the anode or cathode), and may passivate the surface of the cathode or anode. Further still, certain of the additives may sequester certain chemical species generated during the electrochemical processes within the battery cell 40 that would otherwise decompose the electrodes. It should be noted that, oftentimes, high temperature calendar life must be balanced with low temperature performance. That is, additives that serve to stabilize cathodes or anodes at higher temperature can have a deleterious effect on impedance, which is a concern at low temperatures. Certain disclosed embodiments of the electrolytes (e.g., combinations of lithium salt, solvent mixture, and additives) may enable a good balance of both high temperature calendar life and low temperature performance.

The electrolytes of the present disclosure may utilize no additives, or one, two, three, or more additives, depending on the chemistry of the anode and cathode, as well as the particular electrolyte solvents and lithium salts utilized. Also, the additives may each be incorporated into the electrolytes of the present disclosure in amounts ranging from between 0.1% by weight (wt %) to 5 wt %, based on the weight of the electrolyte composition. Indeed, the weight percentages provided herein are all intended to denote a weight percentage based on the total weight of the overall electrolyte. In certain embodiments, each of these additives may be included, alone or in combination, at a concentration between 0.5 wt % and 2.0 wt %, such as between 0.5 wt % and 1.5 wt %, or 1 wt %. If the concentration of the one or more additives is too great, the impedance at the anode and/or cathode of the battery cell 40 may detrimentally increase. On the other hand, if the concentration of the one or more additives is too low, the high-temperature longevity of the anode and/or cathode of the battery cell 40 may suffer (e.g., the beneficial properties of the additives may not be realized), unless otherwise addressed through the use of certain lithium salt and electrolyte solvent combinations. In certain embodiments, as noted above, certain additives may be represented in a molarity. For example, certain compositions may include LiFSI, LiDFOB, LiBOB, or LiPF₆ in amounts of between 0.05 M and 0.2 M, such as 0.1 M.

A non-limiting list of example classes of additives include: sultone-based additives, imide-based additives, borate-based additives, cyclic carbonate-based additives, fluorinated cyclic carbonate-based additives, fluorinated ester-based additives, sulfone-based additives, fluorinated borate-based additives, amide-based additives, amine-based additives, linear carbonate-based additives, and fluorinated linear carbonate-based additives. A non-limiting list of example additives include: lithium bis(oxalato)borate (LiBOB), vinylene carbonate (VC), propane sultone (PS), lithium bistrifluoromethylsulfonylimide (LiTFSI), lithium bisfluorosulfonyl imide (LiFSI), lithium difluoro(oxalato)borate (LiDFOB), triethylamine (TEA), and fluoroethylene carbonate (FEC).

Other additives may be used in addition to or in lieu of any one or a combination of the additives described above. For example, certain of the electrolytes described herein may include one or more vinyl trialkoxysilanes configured to reduce interfacial impedance at either or both of the electrodes of the battery cell 40. Non-limiting examples of vinyl trialkoxysilanes may include compounds having the formula (X¹)(X²)(X³)(X⁴)Si, where X¹, X², and X³ are independently (OR) groups, where R is an alkyl chain having, for example, between 1 and 4 carbons (e.g., methyl, ethyl, n-propyl, isopropyl, n-butyl, isobutyl, or tert-butyl). X⁴ is a vinyl group that is substituted or unsubstituted in addition to its bonding to the Si atom. X¹, X², X³, and X⁴ are each covalently bonded directly to the Si atom, and X¹, X², and X³ may be the same or different. Specific, but non-limiting examples of vinyl trialkoxy silanes include vinyl trimethoxysilane (VTMS) and vinyl triethoxysilane (VTES).

Partially fluorinated esters may be used in addition to or in lieu of the additives noted above, and may also reduce interfacial impedance at either or both of the electrodes of the battery cell 40. The partially fluorinated esters may include condensation products of fluorinated or partially fluorinated alcohols (e.g., trifluoroethanol) with a non-fluorinated carboxylic acid (e.g., acetic, propionic, or butyric acid), or condensation products of non-fluorinated alcohols (e.g., methanol, ethanol, propanol, butanol) with fluorinated or partially fluorinated carboxylic acids (e.g., trifluoroacetic acid). The fluorinations occur at carbon positions of the alcohol or carboxylic acid. 2,2,2-trifluoroethyl butyrate (TFEB) and ethyl trifluoroacetate (ETFA) are examples of such partially fluorinated esters.

Again, each of these additives may affect the performance of the battery cell 40 in different ways. Further, it should be emphasized that the selection of the particular additives for use in the presently disclosed electrolytes is not simply a matter of selection based on their individual properties. Rather, their selection is based on a synergistic effect with the other compounds present within the electrolyte. Indeed, it should be noted that the performance resulting from the selection of specific additives in combination with specific solvent mixtures, as well as their relative amounts, can be very difficult to predict.

Further, as set forth below, it should be noted that an additive mixture may include only selected additives, such as a combination of VC and LiDFOB, or a combination of VC and LiBOB. In certain embodiments, an additive mixture may be considered to consist essentially of VC and LiDFOB, consist essentially of VC and LiBOB, consist essentially of VC and LiFSI, consist essentially of VC, or consist essentially of LiFSI, for example, where the listed additives are present as the only additives in the electrolyte. Indeed, it has been found that LiFSI can be used in place of LiBOB as an electrolyte additive to provide enhanced performance and stability during cell operation. In certain embodiments, the addition of other additives to certain of the electrolytes disclosed below may have a marked (e.g., unintended) effect on the performance of the lithium ion battery cells. That is, the inclusion of other additives not listed will almost certainly have some measurable effect on the performance of the battery cell 40.

### Formation of the Electrolyte

In certain embodiments, the electrolyte may be formed by first generating an initial solution of the lithium salt (the main conductor of lithium ions) in the solvent mixture, and then adding (e.g., admixing) one or more additives to the resulting lithium ion solution yield the final electrolyte. In certain other embodiments, such as when an additive is a lithium salt (e.g., LiBOB, LiFSI), the additive and the lithium salt may be provided to the solvent mixture separately or as a mixture. Indeed, the order in which these materials are added to one another may vary, depending on various considerations, such as the processability (e.g. solubility) of certain materials.

Electrolytes produced in accordance with certain embodiments of the present disclosure may utilize any one or a combination of the lithium salts, electrolyte solvents, and electrolyte additives disclosed above. Example electrolyte formulations may include, for example, LiFSI used as an additive or as the main lithium salt as set forth in the following list of examples:
1. 1.2 M LiPF₆, PC+EMC+DMC+MB (20:30:40:10)+1% VC+0.5% LiFSI
2. 1.2 M LiPF₆, EC+EMC+DMC+MB (20:30:40:10)+1% VC+05% LiFSI
3. 1.0 M LiFSI, PC+EMC+DMC+B (20:30:40:10)+1% VC

With regard to the use of the aggressive co-solvents such as AN, MA, DME, and DMSO, such solvents may be added to a solvent core (EC+EMC+DMC+x, in 20:20:20:40), which is selected so as to provide improved conductivity at low temperatures. An additive combination configured to protect both the anode and cathode interfaces (e.g., VC and LiBOB) may also be used. The electrolytes may include, by way of non-limiting example:
4. 1.2M LiPF₆, EC+EMC+DMC+AN (20:20:20:40)+1% VC+0.5% LiBOB
5. 1.2M LiPF₆, EC+EMC+DMC+MA (20:20:20:40)+1% VC+0.5% LiBOB
6. 1.2M LiPF₆, EC+EMC+DMC+DME (20:20:20:40), 1% VC, 0.5% LiBOB, 2% TEA
7. 1.2M LiPF₆, EC+EMC+DMC+DMSO (20:20:20:40)+1% VC+0.5% LiBOB

As noted above, electrolyte additives may consist of vinyl silanes or partially fluorinated esters. A list of example electrolytes is set forth below:
8. 1.2 M LiPF₆, EC+EMC+DMC+MB (20:30:40:10)+1% VTMS
9. 1.2 M LiPF₆, EC+EMC+DMC+MB (20:30:40:10)+1% VTES
10. 1.2 M LiPF₆, EC+EMC+DMC+MB (20:30:40:10)+1% TFEB
11. 1.2 M LiPF₆, EC+EMC+DMC+MB (20:30:40:10)+1% ETFA

Again, the electrolytes produced in accordance with the present disclosure may, in some embodiments, be useful in NMC/graphite or NMC/LTO Li-ion battery cells (i.e., where the cathode active material includes NMC, the anode active material includes graphite or LTO). However, the present disclosure is intended to be applicable to other electrode active chemistries as well.

### Example Battery Cell Formation and Performance Characterization Results

### Evaluation of LiFSI

To help illustrate the effect of certain lithium salt, solvent, and additive combinations, several graphical representations are presented in FIGS. 5-8, which present battery cell and electrode performance data for various electrolytes produced in accordance with certain embodiments of the present disclosure. Several tables are also presented below, which include similar data to demonstrate the effect of certain electrolyte material compositions. Further, while presented in the context of certain battery cell chemistries, the formulations disclosed above may have utility in other Li-ion battery cell chemistries that use different cathode and anode active material combinations.

Moving now to the data and referring initially to Table 1, generally good performance characteristics were observed with NMC/graphite three electrode cells containing a number of methyl butyrate-based electrolytes with various additives, including formulations that include LiFSI as an additive. The performance characteristics were evaluated after completing five formation cycles as determined from the coulombic efficiency on the first cycle (being an indication of the inherent stability and the electrode film forming process) and the cumulative irreversible capacity losses. The two cells that contain electrolytes with low methyl butyrate content (10%) and either LiBOB or LiFSI (i.e., JC12 and JC14) displayed very comparable performance, demonstrating that LiFSI may provide beneficial stability as an electrolyte additive.

After the formation cycling, electrochemical characterization of all electrodes from these cells was performed at 20° C., −20° C., −30° C., and −40° C. This included performing Tafel polarization measurements, linear micro-polarization measurements, and Electrochemical Impedance Spectroscopy (EIS) measurements. These techniques are useful in determining the electrode charge transfer resistance, interfacial film resistance, and lithium intercalation kinetics into the anodes and cathodes (with the utilization of the lithium reference electrodes). The electrolyte generally has a strong influence upon the interfacial films that form, as well as the subsequent lithium intercalation kinetics which is directly related to the rate capability of the electrode.

TABLE 1
Formation Characteristics of NMC/graphite cells with Methyl Butyrate and Propyl Butyrate-Based Electrolytes
Containing Various Additives

| | Charge | Discharge | | | Charge | | Cumulative | |
|---|---|---|---|---|---|---|---|---|
| | Capacity | Capacity | | | Capacity | Reversible | Irreversible | Coulombic |
| | (Ah) | (Ah) | Irreversible | Coulombic | (Ah) | Capacity | Capacity | Efficiency |
| | 1st | 1st | Capacity | Efficiency | 5th | (Ah) | (1st-5th | (5th |
| Electrolyte Type | Cycle | Cycle | (1st Cycle) | (1st Cycle) | Cycle | 5th Cycle | Cycle) | Cycle) |
| 1.2M LiPF₆ in EC + | 0.1501 | 0.1329 | 0.017 | 88.52 | 0.1305 | 0.1289 | 0.0254 | 98.79 |
| EMC (30:70 vol %) | | | | | | | | |
| 1.2M LiPF₆ + 0.10M | 0.1509 | 0.1354 | 0.016 | 89.67 | 0.1267 | 0.1247 | 0.0249 | 98.46 |
| LiBOB in EC + EMC + | | | | | | | | |
| MB (20:20:60 vol %) | | | | | | | | |
| 1.2M LiPF₆ in EC + | 0.1534 | 0.1286 | 0.025 | 83.89 | 0.1293 | 0.1276 | 0.0341 | 98.69 |
| EMC + MB (20:20:60 | | | | | | | | |
| vol %) + 4% FEC | | | | | | | | |
| 1.2M LiPF6 + 0.10M | 0.1603 | 0.1305 | 0.030 | 81.40 | 0.1325 | 0.1306 | 0.0384 | 98.56 |
| LiDFOB in FEC + | | | | | | | | |
| EMC + MB (20:20:60 | | | | | | | | |
| vol %) | | | | | | | | |
| 1.20M LiPF6 + 0.10M | 0.1537 | 0.1309 | 0.023 | 85.19 | 0.1251 | 0.1224 | 0.0362 | 97.80 |
| LiDFOB in EC + EMC + | | | | | | | | |
| MB (20:20:60 vol %) | | | | | | | | |
| 1.20M LiPF6 in EC + | 0.1543 | 0.1306 | 0.024 | 84.63 | 0.1226 | 0.1190 | 0.0421 | 97.06 |
| EMC + MB (20:20:60 | | | | | | | | |
| vol %) + 1% PS | | | | | | | | |
| 1.20M LiPF6 in EC + | 0.1538 | 0.1313 | 0.022 | 85.40 | 0.1247 | 0.1224 | 0.0348 | 98.16 |
| EMC + MB (20:20:60 | | | | | | | | |
| vol %) + 1% VC | | | | | | | | |
| 1.20M LiPF6 + 0.10M | 0.1519 | 0.1289 | 0.023 | 84.86 | 0.1253 | 0.1234 | 0.0332 | 98.49 |
| LiDFOB in FEC + | | | | | | | | |
| EMC + PB (20:20:60 | | | | | | | | |
| vol %) | | | | | | | | |
| 1.20M LiPF6 in EC + | 0.1545 | 0.1313 | 0.023 | 85.02 | 0.1213 | 0.1186 | 0.0379 | 97.79 |
| EMC + MB (20:20:60 | | | | | | | | |
| vol %) + 1% VC, 1% PS, | | | | | | | | |
| 0.5% LiBOB (Baseline) | | | | | | | | |
| 1.20M LiPF6 in FEC + | 0.1578 | 0.1330 | 0.025 | 84.30 | 0.1254 | 0.1224 | 0.0389 | 97.67 |
| EMC + MB (20:20:60 | | | | | | | | |
| vol %) + 1% VC, 1% | | | | | | | | |
| PS, 0.5% LiDFOB | | | | | | | | |
| 1.20M LiPF6 in EC + | 0.1544 | 0.1304 | 0.024 | 84.46 | 0.1249 | 0.1228 | 0.0351 | 98.33 |
| EMC + DMC + MB | | | | | | | | |
| (20:30:40:10 vol %) + | | | | | | | | |
| 1% VC + 0.5% LiBOB | | | | | | | | |
| 1.20M LiPF6 in EC + | 0.1550 | 0.1317 | 0.023 | 84.96 | 0.1275 | 0.1257 | 0.0338 | 98.55 |
| EMC + DMC + MB | | | | | | | | |
| (20:30:40:10 vol %) + | | | | | | | | |
| 1% VC + 0.5% LiFSI | | | | | | | | |
| 1.20M LiPF6 in EC + | 0.1538 | 0.1297 | 0.024 | 84.32 | 0.1267 | 0.1247 | 0.0325 | 98.45 |
| EMC + DMC + MB | | | | | | | | |
| (30:20:20:30 vol %) + | | | | | | | | |
| 1% VC + 0.5% LiDFOB | | | | | | | | |

As noted above, LiFSI may be used as the main or primary lithium salt (e.g., as the only lithium salt), and LiFSI is believed to result in a more stable electrochemical cell compared to other lithium salts such as LiPF₆ and LiTFSI. As shown in Table 2, good performance was obtained when LiFSI-containing electrolytes were evaluated in NMC/LTO coin cells. As noted, comparable capacities and coulombic efficiencies were obtained, including in embodiments where LiPF₆ was entirely replaced with LiFSI.

TABLE 2
Formation Characteristics of NMC/LTO Cells with Methyl Butyrate-Based Electrolytes Containing LiFSI and Various Additives

| | | | | | | | | | Cumulative | |
|---|---|---|---|---|---|---|---|---|---|---|
| | | | | | | | Charge | | Irreversible | |
| | | Total | Charge | Discharge | Irreversible | | Capacity | Reversible | Capacity | |
| | | Cathode | Capacity | Capacity | Capacity | Coulombic | (mAh) | Capacity | (1st-5th | Coulombic |
| | | Weight | (mAh) | (mAh) | (mAh) | Efficiency | 5th | (mAh) | Cycle) | Efficiency |
| Electrolyte Type | Cell Type | (g) | 1st Cycle | 1st Cycle | (1st Cycle) | (1st Cyle) | Cycle | 5th Cycle | (mAh) | (5th Cycle) |
| 1.20M LiPF₆ in PC + | NMC/ | 0.0248 | 1.9413 | 1.7123 | 0.229 | 88.21 | 1.7757 | 1.7671 | 0.2610 | 99.52 |
| EMC + DMC + MB | LTO | | | | | | | | | |
| (20:30:40:10 vol %) + | | | | | | | | | | |
| 1% VC + 0.5% LiFSI | | | | | | | | | | |
| 1.20M LiPF₆ in PC + | NMC/ | 0.0248 | 1.9564 | 1.7296 | 0.227 | 88.41 | 1.7884 | 1.7824 | 0.2469 | 99.67 |
| EMC + DMC + MB | LTO | | | | | | | | | |
| (20:30:40:10 vol %) + | | | | | | | | | | |
| 1% VC + 0.5% LiFSI | | | | | | | | | | |
| 1.20M LiPF₆ in EC + | NMC/ | 0.0247 | 1.9781 | 1.7459 | 0.232 | 88.26 | 1.8047 | 1.7978 | 0.2569 | 99.61 |
| EMC + DMC + MB | LTO | | | | | | | | | |
| (20:30:40:10 vol %) + | | | | | | | | | | |
| 1% VC + 0.5%LiFSI | | | | | | | | | | |
| 1.20M LiPF₆ in | Graphite/ | 0.0248 | 2.0092 | 1.7736 | 0.236 | 88.27 | 1.8352 | 1.8262 | 0.2689 | 99.51 |
| EC + EMC + DMC + | NMC | | | | | | | | | |
| MB (20:30:40:10 vol | | | | | | | | | | |
| %) + 1% VC + 0.5% | | | | | | | | | | |
| LiFSI | | | | | | | | | | |
| 1.20M LiPF₆ in | NMC/ | 0.0248 | 1.9373 | 1.7049 | 0.232 | 88.00 | 1.7637 | 1.7574 | 0.2658 | 99.65 |
| PC + EMC + DMC + | LTO | | | | | | | | | |
| MB (20:30:40:10 vol | | | | | | | | | | |
| %) + 1% VC + 0.5% | | | | | | | | | | |
| LiDFOB | | | | | | | | | | |
| 1.20M LiPF₆ in | NMC/ | 0.0247 | 1.9420 | 1.7142 | 0.228 | 88.27 | 1.7473 | 1.7329 | 0.2847 | 99.18 |
| PC + EMC + DMC + | LTO | | | | | | | | | |
| MB (20:30:40:10 vol | | | | | | | | | | |
| %) + 1% VC + 0.5% | | | | | | | | | | |
| LiDFOB | | | | | | | | | | |
| 1.20M LiFSI in | NMC/ | 0.0248 | 1.9689 | 1.7283 | 0.241 | 87.78 | 1.7778 | 1.7718 | 0.2667 | 99.67 |
| PC + EMC + DMC + | LTO | | | | | | | | | |
| MB (20:30:40:10 vol | | | | | | | | | | |
| %) + 1% VC | | | | | | | | | | |
| 1.20M LiFSI in | NMC/ | 0.0247 | 1.9663 | 1.7222 | 0.244 | 87.59 | 1.7846 | 1.7774 | 0.2785 | 99.59 |
| PC + EMC + DMC + | LTO | | | | | | | | | |
| MB (20:30:40:10 vol | | | | | | | | | | |
| %) + 1% VC | | | | | | | | | | |

After performing the formation cycling, the cells were subjected to systematic discharge rate characterization testing over a wide temperature range. These tests included charging the cells at ambient temperature and then placing the cells in a temperature-controlled bath for at least four hours prior to discharging at the desired temperatures. The results of these studies are summarized in Table 3. As noted, all cells display somewhat comparable capacities at −20° C. and −25° C. In general, LiFSI appears to be comparable to LiDFOB as an additive in terms of capacity retention.

TABLE 3
Low Temperature Discharge Characteristics of NMC/LTO Cells with Methyl
Butyrate-Based Electrolytes Containing LiFSI and Various Additives

| | | 1.2M LiPF₆ in | | 1.2M LiPF₆ in | | 1.2M LiPF₆ in | | 1.2M LiPF₆ in | |
|---|---|---|---|---|---|---|---|---|---|
| | | PC + EMC + | | PC + EMC + | | EC + EMC + | | EC + EMC + | |
| | | DMC + MB | | DMC + MB | | DMC + MB | | DMC + MB | |
| | | (20:30:40:10) + | | (20:30:40:10) + | | (20:30:40:10) + | | (20:30:40:10) + | |
| | | 1% VC + | | 1% VC + | | 1% VC + | | 1% VC + | |
| Electrolyte Type | | 0.5% LiFSI | | 0.5% LiFSI | | 0.5% LiFSI | | 0.5% LiFSI | |
| | Discharge | Capacity | Percent | Capacity | Percent | Capacity | Percent | Capacity | Percent |
| Temp | Rate | (Ah) | (%) | (Ah) | (%) | (Ah) | (%) | (Ah) | (%) |
| +20° C. | 0.20 | 0.00177 | 100.00 | 0.00178 | 100.00 | 0.00180 | 100.00 | 0.00183 | 100.00 |
| −20° C. | 0.20 | 0.00127 | 71.89 | 0.00128 | 71.77 | 0.00129 | 71.89 | 0.00135 | 73.77 |
| | 1.00 | 0.00107 | 60.67 | 0.00108 | 60.49 | 0.00107 | 59.55 | 0.00112 | 61.31 |
| | 3.00 | 0.00091 | 51.74 | 0.00092 | 51.41 | 0.00090 | 50.22 | 0.00094 | 51.61 |
| | 5.00 | 0.00079 | 44.82 | 0.00079 | 44.41 | 0.00077 | 42.87 | 0.00079 | 43.53 |
| −25° C. | 0.20 | 0.00120 | 67.99 | 0.00121 | 67.78 | 0.00121 | 67.32 | 0.00127 | 69.46 |
| | 1.00 | 0.00100 | 56.54 | 0.00101 | 56.45 | 0.00099 | 55.23 | 0.00104 | 56.83 |
| | 3.00 | 0.00082 | 46.36 | 0.00082 | 45.92 | 0.00081 | 44.79 | 0.00084 | 45.77 |
| | 5.00 | 0.00061 | 34.52 | 0.00060 | 33.88 | 0.00051 | 28.54 | 0.00051 | 28.20 |
| (to | 7.00 | 0.00039 | 21.89 | 0.00041 | 22.99 | 0.00030 | 16.74 | 0.00031 | 17.06 |
| 0.50 V) | | | | | | | | | |
| −30° C. | 0.20 | 0.00113 | 63.75 | 0.00114 | 63.91 | 0.00113 | 63.09 | 0.00119 | 64.99 |
| | 1.00 | 0.00092 | 52.20 | 0.00093 | 52.36 | 0.00091 | 50.69 | 0.00095 | 51.93 |
| | 3.00 | 0.00069 | 38.88 | 0.00068 | 38.05 | 0.00065 | 36.35 | 0.00067 | 36.91 |
| (to | 5.00 | 0.00047 | 26.54 | 0.00049 | 27.57 | 0.00036 | 19.77 | 0.00036 | 19.75 |
| 0.50 V) | | | | | | | | | |
| (to | 7.00 | 0.00023 | 12.98 | 0.00024 | 13.49 | 0.00019 | 10.68 | 0.00020 | 10.78 |
| 0.50 V) | | | | | | | | | |
| | | 1.2M LiPF₆ in | | 1.2M LiPF₆ in | | | | | |
| | | PC + EMC + | | PC + EMC + | | 1.2M LiFSI in | | 1.2M LiFSI in | |
| | | DMC + MB | | DMC + MB | | PC + EMC + | | PC + EMC + | |
| | | (20:30:40:10) + | | (20:30:40:10) + | | DMC + MB | | DMC + MB | |
| | | 1% VC + | | 1% VC + | | (20:30:40:10) + | | (20:30:40:10) + | |
| Electrolyte Type | | 0.5% LiDFOB | | 0.5% LiDFOB | | 1% VC | | 1% VC | |
| | Discharge | Capacity | Percent | Capacity | Percent | Capacity | Percent | Capacity | Percent |
| Temp | Rate | (Ah) | (%) | (Ah) | (%) | (Ah) | (%) | (Ah) | (%) |
| +20° C. | 0.20 | 0.00176 | 100.00 | 0.00173 | 100.00 | 0.00177 | 100.00 | 0.00178 | 100.00 |
| −20° C. | 0.20 | 0.00125 | 71.38 | 0.00123 | 70.88 | 0.00126 | 70.99 | 0.00129 | 72.32 |
| | 1.00 | 0.00106 | 60.20 | 0.00104 | 60.13 | 0.00105 | 59.01 | 0.00107 | 60.30 |
| | 3.00 | 0.00090 | 51.43 | 0.00089 | 51.54 | 0.00088 | 49.40 | 0.00090 | 50.38 |
| | 5.00 | 0.00079 | 45.03 | 0.00076 | 43.63 | 0.00074 | 41.50 | 0.00076 | 43.00 |
| −25° C. | 0.20 | 0.00119 | 67.48 | 0.00117 | 67.33 | 0.00116 | 65.53 | 0.00119 | 66.78 |
| | 1.00 | 0.00099 | 56.20 | 0.00098 | 56.34 | 0.00094 | 53.27 | 0.00094 | 53.07 |
| | 3.00 | 0.00081 | 46.29 | 0.00080 | 46.02 | 0.00075 | 42.50 | 0.00073 | 41.25 |
| | 5.00 | 0.00064 | 36.41 | 0.00057 | 33.17 | 0.00047 | 26.64 | 0.00043 | 24.30 |
| (to | 7.00 | 0.00048 | 27.06 | 0.00036 | 20.85 | 0.00009 | 5.25 | 0.00012 | 6.88 |
| 0.50 V) | | | | | | | | | |
| −30° C. | 0.20 | 0.00111 | 63.38 | 0.00110 | 63.59 | 0.00079 | 44.47 | 0.00086 | 48.39 |
| | 1.00 | 0.00092 | 52.24 | 0.00092 | 52.83 | 0.00078 | 44.11 | 0.00073 | 41.15 |
| | 3.00 | 0.00069 | 39.46 | 0.00067 | 38.68 | 0.00050 | 28.18 | 0.00049 | 27.54 |
| (to | 5.00 | 0.00056 | 31.97 | 0.00044 | 25.43 | 0.0001 | 79.41 | 0.00019 | 10.72 |
| 0.50 V) | | | | | | | | | |
| (to | 7.00 | 0.00027 | 15.17 | 0.00022 | 12.48 | 0.0000 | 94.99 | 0.0001 | 16.09 |
| 0.50 V) | | | | | | | | | |

As the data suggests, based on the initial impedance obtained for the tested battery cells, LiFSI salt may be promising as a replacement for LiPF₆ in terms of low temperature area specific impedance (ASI) with the NMC/LTO system. This may be further appreciated with reference to FIG. 5, which is a plot 90 of ASI as a function of percent state of charge (% SOC) for NMC/LTO battery cells that variously incorporate LiFSI and LiDFOB. Specifically, the cells include a solvent mixture of PC/EMC/DMC/MB (20/30/40/10 vol %), with 1 wt % VC and 0.5 wt % LiFSI or LiDFOB, or with LiFSI as a replacement for LiPF₆ with 1 wt % VC as the only additive. The data was collected at −30° C. at a 5C discharge rate using HPPC characterization testing.

As shown, while the electrolytes having 0.5 wt % LiFSI (as an additive) performed comparably to LiDFOB as an additive, the electrolytes employing LiFSI in place of LiPF₆ as the main lithium salt unexpectedly demonstrated markedly lower impedance across the entire SOC range, as denoted by line 92 and line 94, even when LiBOB and LiDFOB were not incorporated. Accordingly, these results suggest that LiFSI produces highly conductive electrolyte solutions and generally produces desirable SEI films at low temperatures, suggesting that these electrolytes may be well-suited for low temperature, high power applications. Indeed, certain embodiments of the lithium ion battery cell in which LiFSI is used as the lithium salt have a lower area specific impedance at −30° C. than if the electrolyte used LiPF₆ as the lithium salt. Also, when using LiFSI as the main lithium salt, the cell may have a lower area specific impedance at −30° C. than if the electrolyte used LiPF₆ as the lithium salt and LiFSI as an additive. Further, desirable characteristics were observed in certain embodiments of the electrolyte employing VC as an additive, and LiFSI as the exclusive lithium salt, but not employing a borate-based additive such as LiBOB or LiDFOB.

### Example Battery Cell Formation and Performance Characterization Results

### Evaluation of AN, MA, DME, and DMSO as Co-Solvents

In accordance with another aspect of the present approach, as noted above, certain aggressive co-solvents may provide improved power capability at low temperatures, due to high ionic conductivity at these temperatures. AN, MA, DME, and DMSO were evaluated in combination with a core solvent mixture of EC/EMC/DMC+X (20:20:20:40, vol %), where X is AN, MA, DME, or DMSO. Of these solvents, AN and MA both demonstrated promise as an electrolyte co-solvent, whereas DME and DMSO were observed to have higher cumulative irreversible capacity losses during formation and poor performance at low temperature. The results of the low temperature discharge characterization testing of these cells are shown in Table 4. As noted, the cells containing AN and MA were able to support high discharge rates at low temperatures (i.e., 3.0 C at −30° C.). It should be noted that these electrolyte formulations included 40% by volume of the low viscosity co-solvent, which was selected to evaluate the stability of the component. Other concentrations may produce different results.

TABLE 4
Discharge rate characterization of NMC/LTO cells at −20° C. to −30° C. with
electrolytes containing AN, MA, DME, or DMSO

| | | | | | | 1.2M LiPF₆ in | | 1.2M LiPF₆ in | |
|---|---|---|---|---|---|---|---|---|---|
| | | 1.2M LiPF₆ in | | 1.2M LiPF₆, in | | EC + EMC + | | EC + EMC + | |
| | | EC + EMC + DMC + | | EC + EMC + DMC + | | DMC + MA | | DMC + MA | |
| | | AN (20:20:20:40) + 1% | | AN (20:20:20:40) + 1% | | (20:20:20:40) + 1% | | (20:20:20:40) + 1% | |
| Electrolyte Type | | VC + 0.5% LiBOB | | VC + 0.5% LiBOB | | VC + 0.5% LiBOB | | VC + 0.5% LiBOB | |
| | Discharge | Capacity | Percent | Capacity | Percent | Capacity | Percent | Capacity | Percent |
| T emp. | Rate | (Ah) | (%) | (Ah) | (%) | (Ah) | (%) | (Ah) | (%) |
| −20° C. | 0.20 | 0.00168 | 100.00 | 0.00169 | 100.00 | 0.00174 | 100.00 | 0.00168 | 100.00 |
| −20° C. | 0.20 | | | | | | | | |
| | 1.00 | 0.00105 | 62.52 | 0.00105 | 62.00 | 0.00107 | 61.74 | 0.00101 | 60.30 |
| | 3.00 | 0.00091 | 54.05 | 0.00089 | 52.46 | 0.00089 | 51.17 | 0.00084 | 49.87 |
| | 5.00 | 0.00083 | 49.18 | 0.00080 | 47.28 | 0.00076 | 44.04 | 0.00072 | 42.98 |
| −25° C. | 0.20 | 0.00118 | 70.21 | 0.00118 | 69.76 | 0.00120 | 69.19 | 0.00114 | 67.85 |
| | 1.00 | 0.00098 | 58.19 | 0.00098 | 57.66 | 0.00100 | 57.72 | 0.00094 | 56.01 |
| | 3.00 | 0.00085 | 50.75 | 0.00080 | 47.13 | 0.00079 | 45.24 | 0.00075 | 44.80 |
| | 5.00 | 0.00076 | 44.84 | 0.00070 | 41.26 | 0.00064 | 36.69 | 0.00061 | 36.34 |
| −30° C. | 0.20 | 0.00111 | 66.01 | 0.00111 | 65.45 | 0.00113 | 64.83 | 0.00106 | 63.36 |
| | 1.00 | 0.00091 | 53.96 | 0.00090 | 53.21 | 0.00092 | 52.78 | 0.00086 | 51.06 |
| | 3.00 | 0.00085 | 50.20 | 0.00078 | 46.14 | 0.00071 | 40.66 | 0.00070 | 41.92 |
| | 5.00 | | | | | | | | |
| | | 1.2M LiPF₆ in | | 1.2M LiPF₆ in | | 1.2M LiPF₆ in | | 1.2M LiPF6 in | |
| | | EC + EMC + DMC + | | EC + EMC + DMC + | | EC + EMC + DMC + | | EC + EMC + DMC + | |
| | | DME (20:20:20:40) + | | DME (20:20:20:40) + | | DMSO (20:20:20:40) + | | DMSO (20:20:20:40) + | |
| | | 1% VC + 0.5% | | 1% VC + 0.5% | | 1% VC + 0.5% | | 1% VC + 0.5% | |
| Electrolyte Type | | LiBOB + 2% TEA | | LiBOB + 2% TEA | | LiBOB | | LiBOB | |
| | Discharge | Capacity | Percent | Capacity | Percent | Capacity | Percent | Capacity | Percent |
| T emp. | Rate | (Ah) | (%) | (Ah) | (%) | (Ah) | (%) | (Ah) | (%) |
| −20° C. | 0.20 | 0.00139 | 100.00 | 0.00146 | 100.00 | 0.00166 | 100.00 | 0.00174 | 100.00 |
| −20° C. | 0.20 | | | | | | | | |
| | 1.00 | 0.00016 | 11.23 | 0.00013 | 8.86 | 0.00062 | 37.38 | 0.00001 | 0.39 |
| | 3.00 | 0.00001 | 0.90 | 0.00000 | 0.14 | 0.00008 | 4.97 | 0.00000 | 0.02 |
| | 5.00 | 0.00000 | 0.11 | 0.00000 | 0.03 | 0.00003 | 2.00 | 0.00000 | 0.00 |
| −25° C. | 0.20 | 0.00038 | 27.46 | 0.00033 | 22.23 | 0.00086 | 52.21 | 0.00008 | 4.34 |
| | 1.00 | 0.00010 | 6.93 | 0.00008 | 5.55 | 0.00053 | 32.29 | 0.00026 | 14.84 |
| | 3.00 | 0.00000 | 0.10 | 0.00000 | 0.02 | 0.00001 | 0.87 | 0.00000 | 0.00 |
| | 5.00 | 0.00000 | 0.04 | 0.00000 | 0.01 | 0.00000 | 0.20 | 0.00000 | 0.00 |
| −30° C. | 0.20 | 0.00024 | 17.39 | 0.00021 | 14.09 | 0.00065 | 39.03 | 0.00000 | 0.27 |
| | 1.00 | 0.00003 | 2.10 | 0.00002 | 1.46 | 0.00036 | 21.68 | 0.00002 | 1.13 |
| | 3.00 | 0.00000 | 0.02 | 0.00000 | 0.01 | 0.00000 | 0.21 | 0.00000 | 0.00 |
| | 5.00 | | | | | | | | |

### Example Battery Cell Formation and Performance Characterization Results

### Evaluation of Trialkoxysilane and Partially Fluorinated Ester Additives

As noted above, trialkoxysilanes and/or partially fluorinated esters may be used as additives in certain electrolytes of the present disclosure. The trialkoxysilanes and/or partially fluorinated esters may be used in addition to any one or a combination of the other additives described herein, or in lieu of any other additives. Thus, in one embodiment, the only additives used in certain electrolytes of the present disclosure may be trialkoxysilanes and/or partially fluorinated esters.

It is believed that these additives may reduce the interfacial impedance at the electrodes of the battery cell 40. Table 5 includes data obtained for several example additives, VTMS, VTES, TFEB, and ETFA, which were incorporated as the only additive at 1 wt % in a solvent mixture of EC/EMC/DMC/MB (20:30:40:10, vol %) and using 12 M LiPF₆ as the lithium salt in NMC/LTO battery cells. As noted in Table 5, good capacity retention was generally observed, with the exception of certain outlier cells that delivered either low capacity or poor efficiency, which is attributed to cell to cell variation and not the electrolyte properties.

TABLE 5
Formation Characteristics of NMC/LTO cells with Methyl Butyrate-Based Electrolytes Containing Various Silane and
Fluorinated Ester Additives

| | | | | | | | | | | Cumulative | |
|---|---|---|---|---|---|---|---|---|---|---|---|
| | | | | | | | | | | Irreversible | |
| | | | Total | Charge | Discharge | Irreversible | | Charge | Reversible | Capacity | |
| | | | Cathode | Capacity | Capacity | Capacity | Coulombic | Capacity | Capacity | (1st-5th | Coulombic |
| Cell | | | Weight | (mAh) | (mAh) | (mAh) | Efficiency | (mAh) | (mAh) | Cycle) | Efficiency |
| Number | Electrolyte Type | Cell Type | (g) | 1st Cycle | 1st Cycle | (1st Cycle) | (1st Cycle) | 5th Cycle | 5th Cycle | (mAh) | (5th Cycle) |
| JTS-47 | 1.20M LiPF₆ in | NMC/ | 0.0248 | 2.2920 | 1.5015 | 0.791 | 65.51 | 1.9650 | 1.4404 | 2.2920 | 73.30 |
| | EC + EMC + DMC + | LTO | | | | | | | | | |
| | MB (20:30:40:10) + | | | | | | | | | | |
| | 1% VTMS | | | | | | | | | | |
| JTS-48 | 1.20M LiPF₆ in | NMC/ | 0.0248 | 1.8376 | 1.5960 | 0.242 | 86.85 | 1.6646 | 1.6547 | 0.2417 | 99.40 |
| | EC + EMC + DMC + | LTO | | | | | | | | | |
| | MB (20:30:40:10) + | | | | | | | | | | |
| | 1% VTMS | | | | | | | | | | |
| JTS-49 | 1.20M LiPF₆ in | NMC/ | 0.0248 | 1.9000 | 1.6847 | 0.215 | 88.67 | 1.7243 | 1.7080 | 0.2329 | 99.05 |
| | EC + EMC + DMC + | LTO | | | | | | | | | |
| | MB (20:30:40:10) + | | | | | | | | | | |
| | 1% VTES | | | | | | | | | | |
| JTS-50 | 1.20M LiPF₆ in | NMC/ | 0.0248 | 1.8982 | 1.6787 | 0.219 | 88.44 | 1.7182 | 1.6991 | 0.2490 | 98.89 |
| | EC + EMC + DMC + | LTO | | | | | | | | | |
| | MB (20:30:40:10) + | | | | | | | | | | |
| | 1% VTES | | | | | | | | | | |
| JTS-51 | 1.20M LiPF₆ in | NMC/ | 0.0248 | 1.8852 | 1.6740 | 0.211 | 88.80 | 1.7094 | 1.6819 | 0.2658 | 98.39 |
| | EC + EMC + DMC + | LTO | | | | | | | | | |
| | MB (20:30:40:10) + | | | | | | | | | | |
| | 1% TFEB | | | | | | | | | | |
| JTS-52 | 1.20M LiPF₆ in | NMC/ | 0.0248 | 1.9024 | 1.6901 | 0.212 | 88.84 | 1.7299 | 1.7154 | 0.2279 | 99.16 |
| | EC + EMC + DMC + | LTO | | | | | | | | | |
| | MB (20:30:40:10) + | | | | | | | | | | |
| | 1% TFEB | | | | | | | | | | |
| JTS-53 | 1.20M LiPF6 in | NMC/ | 0.0248 | 1.8913 | 1.6752 | 0.216 | 88.57 | 1.7325 | 1.7147 | 0.2450 | 98.97 |
| | EC + EMC + DMC + | LTO | | | | | | | | | |
| | MB (20:30:40:10) + | | | | | | | | | | |
| | 1% ETFA | | | | | | | | | | |
| JTS-54 | 1.20M LiPF6 in | NMC/ | 0.0248 | 1.8660 | 1.5854 | 0.281 | 84.96 | 1.6482 | 1.6213 | 0.4083 | 98.37 |
| | EC + EMC + DMC + | LTO | | | | | | | | | |
| | MB (20:30:40:10) + | | | | | | | | | | |
| | 1% ETFA | | | | | | | | | | |

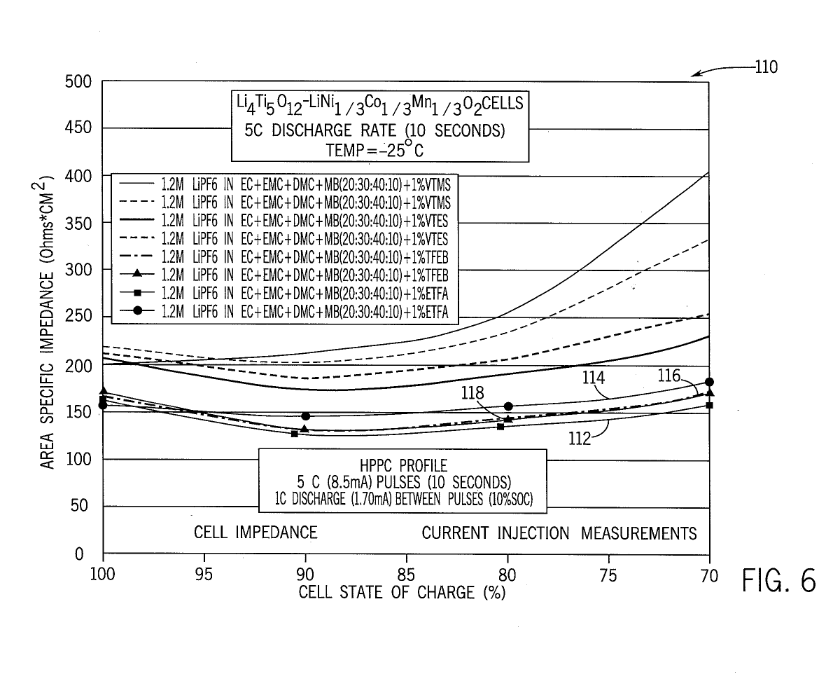

After the formation cycling, the cells were subjected to HPPC profiles at various temperatures to obtain area specific impedance of the cells. As shown in FIG. 6, which is a plot 110 of ASI as a function of cell % SOC obtained at −25° C., the partially fluorinated esters appear to result in lower cell polarization and resistance compared to the vinyl trialkoxysilanes. For example, ETFA, noted by line 112 and line 114, resulted in cells having the lowest impedance, with TFEB, noted by line 116 and line 118, providing comparable performance.

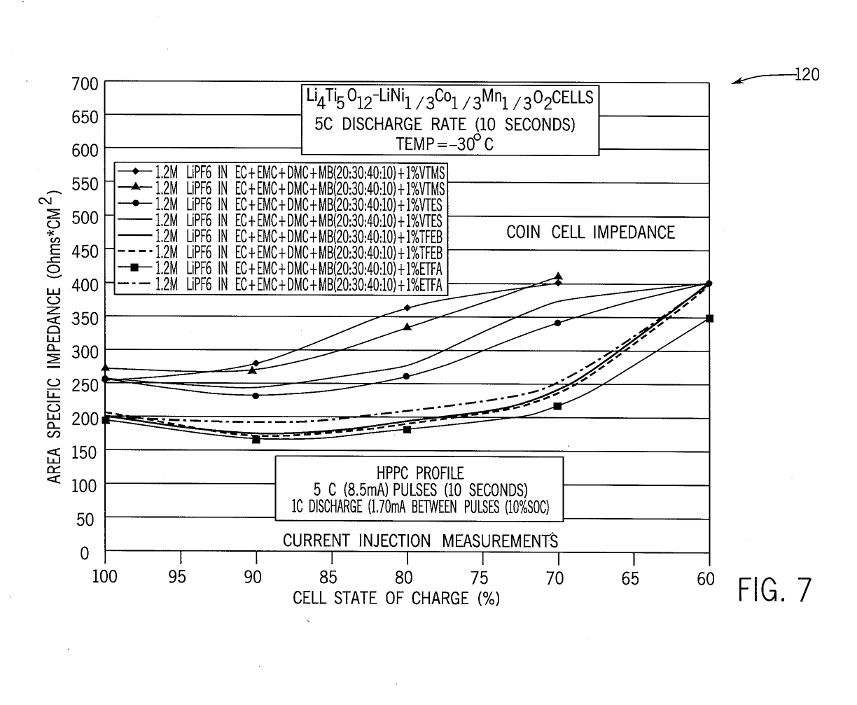

Of the vinyl trialkoxysilane additives, VTES appears to result in more desirable performance compared to VTMS. However, both of the vinyl trialkoxysilane additives were inferior to the partially fluorinated esters. As illustrated in FIG. 7, which is a plot 120 of ASI as a function of cell % SOC, similar performance was also observed at −30° C. That is, the electrolyte containing the ETFA additive provided the lowest cell impedance at low temperature.

One or more of the disclosed embodiments, alone or on combination, may provide one or more technical effects useful in the manufacture of lithium ion battery cell electrolytes, lithium ion battery cells, and lithium ion battery modules. For example, certain embodiments of the present disclosure may enable the manufacture of lithium ion battery cells that having a wide range of operating temperatures, such as temperatures ranging between −40° C. and 60° C. In particular, embodiments of battery cells of the present disclosure include an electrolyte using LiFSI as an additive or as a lithium salt (e.g., the main conductor of lithium ions in the electrolyte), an electrolyte using one or more vinyl trialkoxysilane additives, an electrolyte using one or more partially fluorinated ester additives, an electrolyte using a solvent mixture that includes AN, MA, DME, or DMSO. Indeed, disclosed embodiments include a number of ester containing electrolytes that have been demonstrated to result in improved low temperature power capability in NMC/graphite and NMC/LTO Li-ion cells compared to all carbonate-based electrolytes. Disclosed embodiments also include electrolytes containing LiFSI, which has been demonstrated to provide low cell impedance at low temperatures, when used in conjunction with LiPF₆ or as the exclusive lithium salt. Disclosed embodiments also include the use of vinyltrialkoxy silanes such as VTMS and VTES to reduce interfacial impedance of Li-ion cells. In addition, disclosed embodiments include electrolytes incorporating aggressive co-solvents such as AN and MA, which have been demonstrated to improve low temperature performance in NMC/LTO cells. Disclosed embodiments also include electrolytes including partially fluorinated ester additives such as TFEB and ETFA, which have been demonstrated as capable of improving electrolyte/electrode interfacial properties and cell impedance at low temperatures. The disclosed embodiments of the electrolytes enable low resistance at low temperatures (e.g., −30° C.) and good cycle life performance at higher temperatures (e.g., 60° C.). As such, present embodiments enable the production of improved secondary lithium ion battery cells that can provide more current when operating at lower temperatures (e.g., −20° C. and below), and can also provide good longevity throughout successive cycles when operating at higher temperatures (e.g., 45° C. and above). The technical effects and technical problems in the specification are exemplary and are not limiting. It should be noted that the embodiments described in the specification may have other technical effects and can solve other technical problems.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A lithium ion battery cell, comprising:
a housing;
a cathode disposed within the housing, wherein the cathode comprises a cathode active material;
an anode disposed within the housing, wherein the anode comprises an anode active material; and
an electrolyte disposed within the housing and in contact with the cathode and anode, wherein the electrolyte includes a solvent mixture and a lithium salt serving as a primary lithium ion conductor in the electrolyte to allow for lithium ion intercalation and deintercalation processes at the cathode and the anode during charging and discharging of the lithium ion battery cell; and
wherein the solvent mixture includes a cyclic carbonate and one or more non-cyclic carbonates, wherein the lithium salt is lithium bis(fluorosulfonyl)imide (LiFSI), and wherein the solvent mixture and LiFSI are configured to enhance the low temperature performance of the lithium ion battery cell at operating temperatures below 0° C.

2. The lithium ion battery cell of claim 1, wherein LiFSI is the only lithium salt used to produce the electrolyte.

3. The lithium ion battery cell of claim 1, wherein the lithium ion battery cell has a lower area specific impedance at −30° C. than if the electrolyte used LiPF₆ as the lithium salt.

4. The lithium ion battery cell of claim 1, wherein the lithium ion battery cell has a lower area specific impedance at −30° C. than if the electrolyte used LiPF₆ as the lithium salt and LiFSI as an additive.

5. The lithium ion battery cell of claim 1, wherein the solvent mixture includes a non-cyclic ester.

6. The lithium ion battery cell of claim 1, wherein the electrolyte includes a carbonate-based additive but does not include a borate-based additive.

7. The lithium ion battery cell of claim 1, wherein LiFSI is the only lithium salt used to produce the electrolyte, and wherein the solvent mixture consists essentially of the cyclic carbonate, the one or more non-cyclic carbonates, and a non-cyclic ester.

8. The lithium ion battery cell of claim 1, wherein LiFSI is the only lithium salt used to produce the electrolyte, and wherein the solvent mixture consists essentially of:
the cyclic carbonate in an amount between 5 vol % and 30 vol % based on the total volume of the solvent mixture;
the one or more non-cyclic carbonates, present as a first non-cyclic carbonate and a second non-cyclic carbonate, wherein the first and second non-cyclic carbonates together represent between 50 vol % and 80 vol % of the total volume of the solvent mixture; and
a non-cyclic ester in an amount between 5 vol % and 20 vol %, based on the total volume of the solvent mixture.

9. The lithium ion battery cell of claim 8, wherein the cyclic carbonate is propylene carbonate (PC), the first non-cyclic carbonate is ethyl methyl carbonate (EMC), the second non-cyclic carbonate is dimethyl carbonate (DMC), the non-cyclic ester is methyl butyrate (MB), and wherein the electrolyte includes vinylene carbonate (VC) as an additive but does not include a borate-based additive or LiPF₆.

10. The lithium ion battery cell of claim 9, wherein the solvent mixture is PC/EMC/DMC/MB (20:30:40:10 vol %), VC is present in an amount of 1 wt % based on the weight of the electrolyte, and LiFSI is present in a concentration between 1.0 M and 1.6 M.

11. The lithium ion battery cell of claim 1, wherein the anode active material includes a titanate-based material or a graphite-based material.

12. The lithium ion battery cell of claim 1, wherein the cathode active material includes a lithium nickel manganese cobalt oxide (NMC) active material, a lithium cobalt oxide (LCO) active material, a lithium cobalt aluminum oxide (NCA) active material, a lithium metal oxide spinel (LMO-spinel) active material, or any combination thereof.

13. A lithium ion battery cell, comprising:
a housing;
a cathode disposed within the housing, wherein the cathode comprises a cathode active material;
an anode disposed within the housing, wherein the anode comprises an anode active material; and
an electrolyte disposed within the housing and in contact with the cathode and anode, wherein the electrolyte includes a solvent mixture, a lithium salt serving as a primary lithium ion conductor in the electrolyte to allow for lithium ion intercalation and deintercalation processes at the cathode and the anode during charging and discharging of the lithium ion battery cell, and lithium bis(fluorosulfonyl)imide (LiFSI) as an additive; and
wherein the solvent mixture includes a cyclic carbonate, a first non-cyclic carbonate and a second non-cyclic carbonate, and wherein the solvent mixture and the LiFSI additive are configured to enhance the low temperature performance of the lithium ion battery cell at operating temperatures below 0° C.

14. The lithium ion battery cell of claim 13, wherein LiFSI is present in an amount between 0.1 wt % and 1.0 wt %, based on the weight of the electrolyte.

15. The lithium ion battery cell of claim 13, wherein LiFSI is present in an amount of 0.5 wt %, based on the weight of the electrolyte.

16. The lithium ion battery cell of claim 13, wherein the electrolyte includes one or more additives, and LiFSI is the only lithium salt used as an additive in the electrolyte.

17. The lithium ion battery cell of claim 16, wherein the one or more additives include a carbonate-based additive.

18. The lithium ion battery cell of claim 17, wherein the carbonate-based additive is vinylene carbonate, and is present in an amount between 1.0 wt % and 2.0 wt %, based on the weight of the electrolyte.

19. The lithium ion battery cell of claim 13, wherein the solvent mixture includes a linear ester.

20. The lithium ion battery cell of claim 13, wherein the solvent mixture consists essentially of the cyclic carbonate, the first non-cyclic carbonate, the second non-cyclic carbonate, and a non-cyclic ester.

21. A lithium ion battery cell, comprising:
a housing;
a cathode disposed within the housing, wherein the cathode comprises a cathode active material;
an anode disposed within the housing, wherein the anode comprises a titanate-based active material; and
an electrolyte disposed within the housing and in contact with the cathode and anode, wherein the electrolyte includes a solvent mixture, a lithium salt, and one or more additives; and
wherein the one or more additives include a vinyl trialkoxysilane, or a partially fluorinated ester, or a combination thereof.

22. The lithium ion battery cell of claim 21, wherein the one or more additives include the vinyl trialkoxysilane, and the vinyl trialkoxysilane is represented by the formula (X¹)(X²)(X³)(X⁴)Si, wherein:
X¹, X², X³, and X⁴ are each covalently bonded directly to the Si atom;
X¹, X², and X³ are independently (OR) groups;
R is an alkyl chain having between 1 and 4 carbons; and
X⁴ is a vinyl group.

23. The lithium ion battery cell of claim 22, the vinyl trialkoxysilane is vinyl trimethoxysilane (VTMS) and vinyl triethoxysilane (VTES).

24. The lithium ion battery cell of claim 21, wherein the one or more additives include the partially fluorinated ester.

25. The lithium ion battery cell of claim 24, wherein the partially fluorinated ester is a condensation product of a fluorinated or partially fluorinated alcohol with a non-fluorinated carboxylic acid.

26. a condensation product of a fluorinated or partially fluorinated carboxylic acid with a non-fluorinated alcohol.

27. The lithium ion battery cell of claim 24, wherein the partially fluorinated ester is 2,2-trifluoroethyl butyrate (TFEB) or ethyl trifluoroacetate (ETFA).
